(19) United States
(12) Patent Application Publication
(10) Pub. No.: US 2026/0362455 A1
(43) Pub. Date: Nov. 12, 2026

(54) ADVANCED INFERENCE NATIVE SIDELINK PARTIAL SENSING

(71) Applicant: QUALCOMM Incorporated, San Diego, CA (US)

(72) Inventors: Sourjya DUTTA, Jersey City, NJ (US); Kapil GULATI, Belle Mead, NJ (US); Tien Viet NGUYEN, Bridgewater, NJ (US); Gabi SARKIS, San Diego, CA (US); Hong CHENG, Basking Ridge, NJ (US)

(21) Appl. No.: 19/200,558

(22) Filed: May 6, 2025

(51) Int. Cl. H04W 72/25; H04L 43/065

(52) U.S. Cl. CPC H04W 72/25; H04L 43/065

(57) ABSTRACT

This disclosure provides methods and apparatuses for optimization or enhancement of partial sensing for sidelink power savings in wireless communication networks. In various examples, a user equipment (UE) sends information associated with sidelink communication to a network entity, obtains, from the network entity, a radio resource control (RRC) configuration including a sidelink information element indicating a sidelink parameter for partial sensing; selects, using the partial sensing, a resource from a resource pool for the sidelink communication, the partial sensing being based at least in part on a UE inference model at the UE or a network inference model at the network entity; and sends data in the selected resource. The methods and apparatuses allow the UE and network to leverage inference models present at one or both the network entity and UE(s) to achieve energy-efficient, or green, sidelink communication.

### TECHNICAL FIELD

The present disclosure relates to wireless communication, and more particularly, to methods and apparatuses for enhancing power savings in sidelink communication.

### DESCRIPTION OF THE RELATED TECHNOLOGY

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

For example, some aspects of wireless communication include direct communication between devices, such as device-to-device (D2D), vehicle-to-everything (V2X), and the like. There exists a need for further improvements in such direct communication between devices. Improvements related to direct communication between devices may be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

One innovative aspect of the subject matter described in this disclosure may be implemented in an apparatus for wireless communication, where the apparatus is a user equipment (UE). The apparatus includes one or more memories, and one or more processors each communicatively coupled with at least one of the one or more memories. The one or more processors, individually or in any combination, are operable to cause the apparatus to obtain, from a network entity, a radio resource control (RRC) configuration including a sidelink information element indicating a sidelink parameter for partial sensing; select, using the partial sensing, a resource from a resource pool for sidelink communication, the partial sensing being based at least in part on a UE inference model at the apparatus or a network inference model at the network entity; and send data in the selected resource.

Another innovative aspect of the subject matter described in this disclosure may be implemented in a method of wireless communication performable at a UE. The method includes obtaining, from a network entity, a RRC configuration including a sidelink information element indicating a sidelink parameter for partial sensing; selecting, using the partial sensing, a resource from a resource pool for sidelink communication, the partial sensing being based at least in part on a UE inference model at the UE or a network inference model at the network entity; and sending data in the selected resource.

Another innovative aspect of the subject matter described in this disclosure may be implemented in an apparatus for wireless communication, where the apparatus is a user equipment (UE). The apparatus includes means for obtaining, from a network entity, a RRC configuration including a sidelink information element indicating a sidelink parameter for partial sensing; means for selecting, using the partial sensing, a resource from a resource pool for sidelink communication, the partial sensing being based at least in part on a UE inference model at the UE or a network inference model at the network entity; and means for sending data in the selected resource.

Another innovative aspect of the subject matter described in this disclosure may be implemented in an apparatus for wireless communication, where the apparatus is a network entity. The apparatus includes one or more memories, and one or more processors each communicatively coupled with at least one of the one or more memories. The one or more processors, individually or in any combination, are operable to cause the apparatus to obtain information associated with sidelink communication, the sidelink communication being in a selected resource from a resource pool; and send to a UE, in response to the information, a RRC configuration including a sidelink information element indicating a sidelink parameter for partial sensing, the partial sensing being based at least in part on a UE inference model at the UE or a network inference model at the apparatus.

Another innovative aspect of the subject matter described in this disclosure may be implemented in a method of wireless communication performable at a network entity. The method includes obtaining information associated with sidelink communication, the sidelink communication being in a selected resource from a resource pool; and sending to a UE, in response to the information, a RRC configuration including a sidelink information element indicating a sidelink parameter for partial sensing, the partial sensing being based at least in part on a UE inference model at the UE or a network inference model at the network entity.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1A is a diagram illustrating an example of a wireless communications system and an access network.

FIG. 1B shows a diagram illustrating an example disaggregated base station architecture.

FIG. 2 is an illustrative block diagram of an example machine learning (ML) model represented by an artificial neural network (ANN).

FIG. 3 is an illustrative block diagram of an example ML architecture that may be used for wireless communications.

FIG. 4A is a diagram illustrating an example of a first frame, in accordance with various aspects of the present disclosure.

FIG. 4B is a diagram illustrating an example of DL channels within a subframe, in accordance with various aspects of the present disclosure.

FIG. 4C is a diagram illustrating an example of a second frame, in accordance with various aspects of the present disclosure.

FIG. 4D is a diagram illustrating an example of UL channels within a subframe, in accordance with various aspects of the present disclosure.

FIG. 5 illustrate example aspects of a sidelink slot structure.

FIG. 6 is a diagram illustrating an example of a base station and a user equipment (UE) in an access network.

FIG. 7 is an illustrative block diagram of an example ML architecture of a first wireless device in communication with a second wireless device.

FIG. 8 is a diagram illustrating an example of a sidelink resource pool in New Radio (NR) vehicle-to-everything (V2X), where sidelink transmissions or receptions may occur.

FIGS. 9A-9C are diagrams illustrating examples of different partial sensing schemes.

FIG. 10 is a diagram illustrating an example of an information element (IE) including radio resource control (RRC) parameters associated with partial sensing in sidelink communication.

FIG. 11 is a diagram illustrating an example of a UE inference model which receives system state information as inputs and which produces partial sensing parameters as outputs based on a profit function.

FIG. 12 is a diagram illustrating an example of a network inference model at a network entity such as base station or core network.

FIGS. 13A-13B are diagrams illustrating an example of partial sensing parameters the network may configure or reconfigure for a sidelink UE.

FIG. 14 is a diagram illustrating an example of a split, data collection and inference model architecture between a network entity and a UE.

FIG. 15 is a call flow diagram between a UE and a base station.

FIG. 16 is a flowchart of a method of wireless communication performable at a UE.

FIG. 17 is a flowchart of a method of wireless communication performable at a network entity.

FIG. 18 is a diagram illustrating an example of a hardware implementation for an example apparatus.

FIG. 19 is a diagram illustrating another example of a hardware implementation for another example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

In certain scenarios such as out of coverage (OoC) network scenarios, it is beneficial for UEs to communicate with one another over sidelink autonomously, that is, under a mode 2 resource allocation, while having some degree of control from the network. This allows a radio access network (RAN) entity to service non-device to device (D2D) users and save network power by eliminating the need to schedule sidelink resources. However, sidelink UEs when operating in an OoC mode or OoC scenarios still operate on a licensed band. Therefore, in the absence of base station scheduling to control these UEs, the UEs sense the channel before transmitting. Such sensing of the sidelink channel is helpful as sidelink transmission may rely on collision avoidance based on transmitter side resource exclusion. Yet, this sensing may be a significant source of power consumption for sidelink UEs.

Furthermore, while some sidelink designs predominantly focused on connected vehicle to everything (C-V2X) communications, sidelink designs may additionally focus on other D2D communication paradigms. Some of these devices may include industrial IoT devices, unmanned aerial vehicles (UAVs), and the like. These devices may be form factor limited and power limited devices. Since these devices may be even more limited in power than a vehicle, intelligent power savings mechanisms are desirable to employ at these devices and allow these devices to operate longer with the limited battery they possess.

Accordingly, sidelink power savings has been a main topic for investigation and standardization in 5G. For instance, partial sensing may be applied to reduce sidelink power consumption, specifically the power consumption associated with continuous channel sensing. Partial sensing may reduce power consumption of sidelink UEs operating in an OoC communication mode by reducing the channel sensing the UE performs. This power savings may be accomplished, for example, using random selection, contiguous partial sensing (CPS), or periodic-based partial sensing (PBPS).

The base station may provide a PBPS and CPS configuration information element (IE) to configure a UE for random resource selection, PBPS, or CPS. The configuration may include various parameters for partial sensing and defining random resource selection, CPS or PBPS operations for a sidelink UE. However, these parameters are generally arbitrarily set and thus may not be optimized to provide power savings for a given UE or network situation. Therefore, it would be helpful to improve native partial sensing operations to optimize or enhance sidelink power savings.

In various aspects of the present disclosure, one or more of the network or sidelink UE may apply native inference (AI/ML) models to at least the aforementioned parameters related to partial sensing. For instance, when a UE applies partial sensing to reduce power consumption by reducing channel sensing operations, an inference model at the UE or the base station or both may be applied to optimize or enhance the partial sensing operation. For example, a network entity may determine via its inference model a set of parameters that may reduce power consumption of multiple UEs, while individual UEs may fine tune these parameters via their respective inference model(s) to trade off communication and device energy efficiency, including device energy consumption metrics and the like. Thus, native partial sensing operations may be improved and sidelink power savings may be optimized or enhanced.

Accordingly, various aspects of the subject matter described in this disclosure relate generally to wireless communication, and more particularly to methods and apparatuses for enhancing power savings in sidelink communication. Some aspects specifically relate to optimization or enhancement of partial sensing for sidelink power savings. In various examples, apparatuses and methods are provided in which a UE obtains, from a network entity, a radio resource control (RRC) configuration including a sidelink information element indicating a sidelink parameter for partial sensing; selects, using the partial sensing, a resource from a resource pool for sidelink communication, the partial sensing being based at least in part on a UE inference model at the UE or a network inference model at the network entity; and sends data in the selected resource. In various examples, apparatuses and methods are similarly provided in which a network entity such as a base station obtains information associated with sidelink communication, the sidelink communication being in a selected resource from a resource pool; and sends to a UE, in response to the information, a RRC configuration including a sidelink information element indicating a sidelink parameter for partial sensing, the partial sensing being based at least in part on a UE inference model at the UE or a network inference model at the network entity. In one aspect, a sidelink UE may rely on its own inference model to determine parameters for partial sensing. In various aspects, the partial sensing parameters the network provides to the UE may indicate flexible thresholds, or optional values, that the UE may apply to perform its partial sensing based on its inference model. In one aspect, a sidelink UE may additionally or alternatively rely on an AI/ML model at the base station, core network, or other network entity to determine sidelink partial sensing parameters.

Particular aspects of the subject matter described in this disclosure may be implemented to realize one or more potential advantages. For example, the disclosed methods and apparatuses may allow the UE and network to leverage inference models present at one or both the network entity and UE(s) to achieve energy-efficient, or green, sidelink communication. The reliance by a UE on its own inference model to determine partial sensing parameters allows information as to a system state of the UE, such as its traffic pattern, energy cost, budget, and the like, to be input into the inference model to predict beneficial partial sensing parameters for that UE. Moreover, the use of flexible thresholds for partial sensing allows the base station to flexibly indicate one or more optional values the UE may selectively apply for a given parameter, rather than a mandatory single value the UE is to apply for a given partial sensing. Furthermore, the reliance on an inference model at the network entity for partial sensing parameters allows for dynamic network entity adjustment of its partial sensing parameters and inference model based on reported UE information. For instance, before or after performing sidelink communication, the UE may collect information such as data, measurements, proximity information, motion information, environment information, device level information, or a combination of the foregoing, and report this information to the base station for the network entity to adjust the value of one or more sidelink partial sensing parameters to be applied by these UEs. Thus, more efficient sidelink power savings may be achieved.

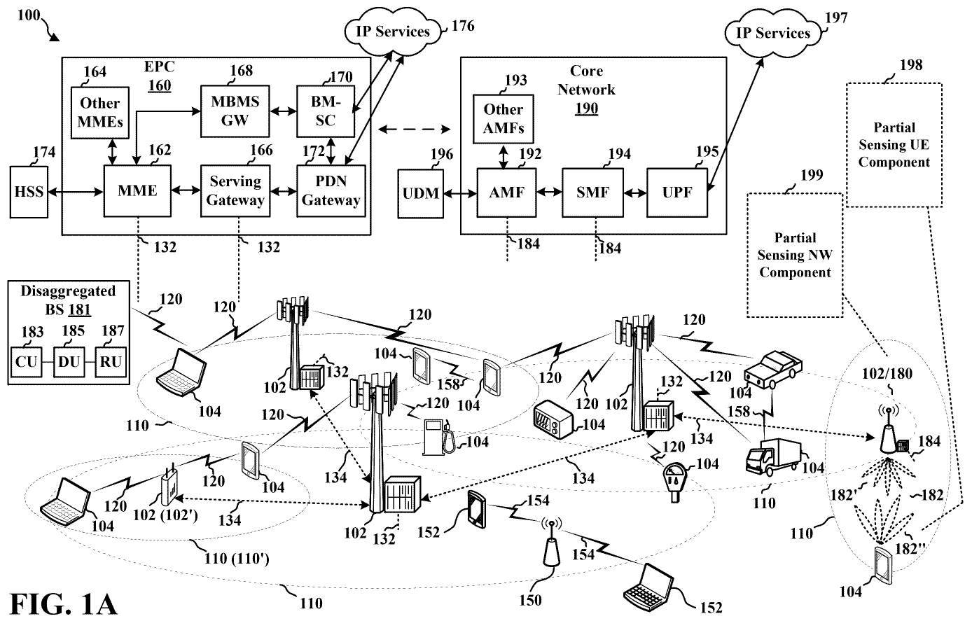

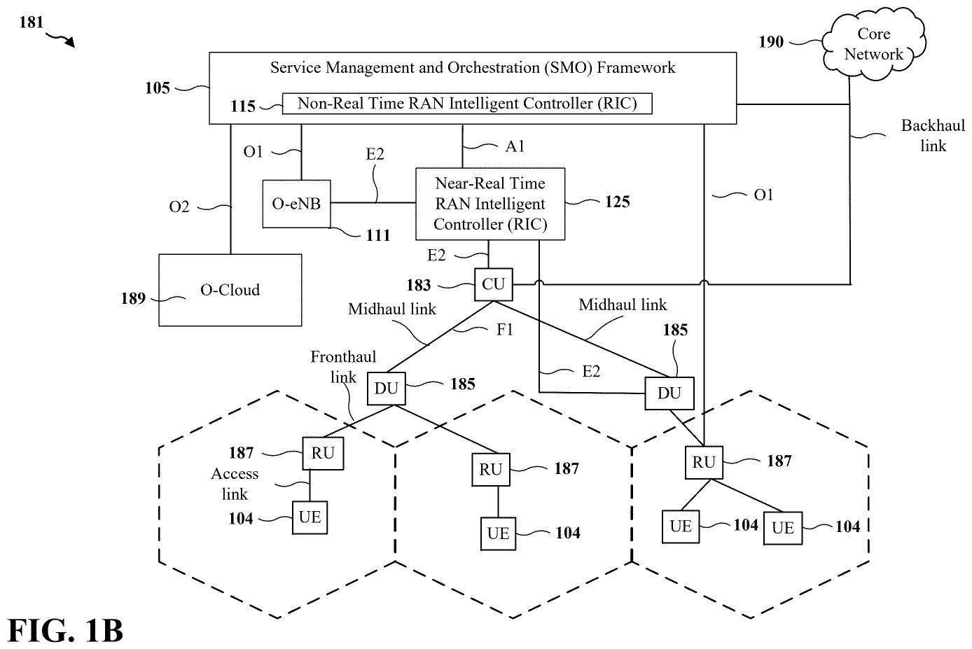

FIG. 1A is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (A4.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a communications device, a wireless communications device, a remote device, a mobile subscriber station, an access terminal, a mobile terminal, a wireless terminal, a remote terminal, a handset, a user agent, a mobile client, a client, or some other suitable terminology.

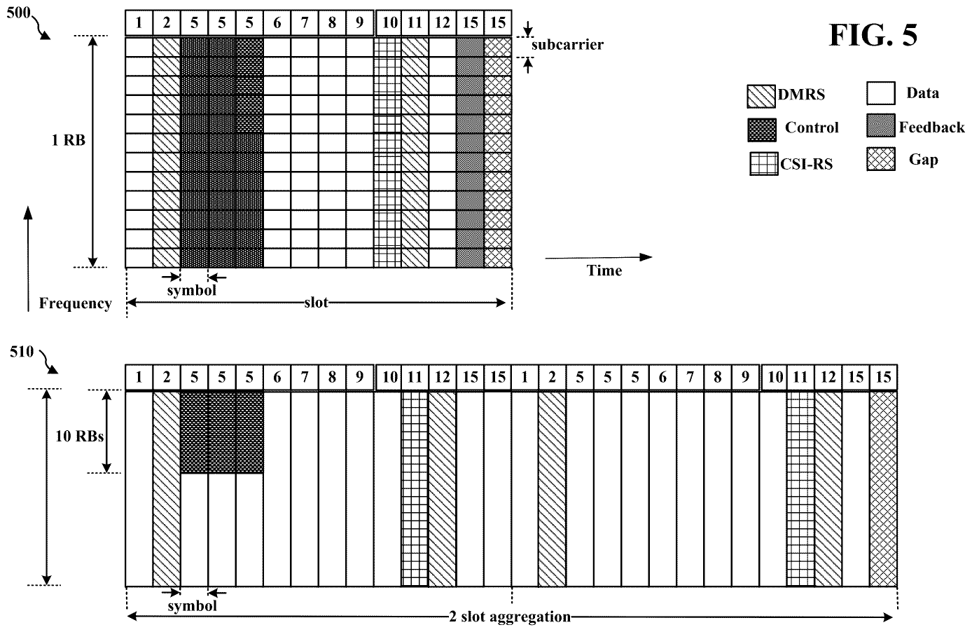

Some wireless communication networks may include vehicle-based communication devices that can communicate from vehicle-to-vehicle (V2V), vehicle-to-infrastructure (V2I) (e.g., from the vehicle-based communication device to road infrastructure nodes such as a Road Side Unit (RSU)), vehicle-to-network (V2N) (e.g., from the vehicle-based communication device to one or more network nodes, such as a base station), and/or a combination thereof and/or with other devices, which can be collectively referred to as vehicle-to-anything (V2X) communications. Referring again to FIG. 1A, in certain aspects, a UE 104, e.g., a transmitting Vehicle User Equipment (VUE) or other UE, may be configured to transmit messages directly to another UE 104. The communication may be based on V2V/V2X/V2I or other D2D communication, such as Proximity Services (ProSe), etc. Communication based on V2V, V2X, V2I, and/or D2D may also be transmitted and received by other transmitting and receiving devices, such as Road Side Unit (RSU) 107, etc. Aspects of the communication may be based on PC5 or sidelink communication, e.g., as described in connection with the example in FIG. 5.

Deployment of communication systems, such as 5G NR systems, may be arranged in multiple manners with various components or constituent parts. In a 5G NR system, or network, a network node, a network entity, a network device, a mobility element of a network, a RAN node, a core network node, a network element, or a network equipment, such as a BS, or one or more units (or one or more components) performing base station functionality, may be implemented in an aggregated or disaggregated architecture. For example, a BS (such as a Node B (NB), eNB, NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station 181 may be configured to utilize a protocol stack that is physically or logically distributed among two or more units (such as one or more central units (CU), one or more distributed units (DUs), or one or more radio units (RUs)). In some aspects, a CU 183 may be implemented within a RAN node, and one or more DUs 185 may be co-located with the CU, or alternatively, may be geographically or virtually distributed throughout one or multiple other RAN nodes. The DUs may be implemented to communicate with one or more RUs 187. Each of the CU, DU and RU also may be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which may enable flexibility in network design. The various units of the disaggregated base station, or disaggregated RAN architecture, may be configured for wired or wireless communication with at least one other unit.

FIG. 1B shows a diagram illustrating an example disaggregated base station 181 architecture. The disaggregated base station 181 architecture may include one or more CUs 183 that may communicate directly with core network 190 via a backhaul link, or indirectly with the core network 190 through one or more disaggregated base station units (such as a Near-Real Time RIC 125 via an E2 link, or a Non-Real Time RIC 115 associated with a Service Management and Orchestration (SMO) Framework 105, or both). A CU 183 may communicate with one or more DUs 185 via respective midhaul links, such as an F1 interface. The DUs 185 may communicate with one or more RUs 187 via respective fronthaul links. The RUs 187 may communicate respectively with UEs 104 via one or more radio frequency (RF) access links. In some implementations, the UE 104 may be simultaneously served by multiple RUs 187.

Each of the units, i.e., the CUs 183, the DUs 185, the RUs 187, as well as the Near-RT RICs 125, the Non-RT RICs 115 and the SMO Framework 105, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, may be configured to communicate with one or more of the other units via the transmission medium. For example, the units may include a wired interface configured to receive or transmit signals over a wired transmission medium to one or more of the other units. Additionally, the units may include a wireless interface, which may include a receiver, a transmitter or transceiver (such as a radio frequency (RF) transceiver), configured to receive or transmit signals, or both, over a wireless transmission medium to one or more of the other units.

In some aspects, the CU 183 may host higher layer control functions. Such control functions may include radio resource control (RRC), packet data convergence protocol (PDCP), service data adaptation protocol (SDAP), or the like. Each control function may be implemented with an interface configured to communicate signals with other control functions hosted by the CU 183. The CU 183 may be configured to handle user plane functionality (i.e., Central Unit-User Plane (CU-UP)), control plane functionality (i.e., Central Unit-Control Plane (CU-CP)), or a combination thereof. In some implementations, the CU 183 may be logically split into one or more CU-UP units and one or more CU-CP units. The CU-UP unit may communicate bidirectionally with the CU-CP unit via an interface, such as the E1 interface when implemented in an O-RAN configuration. The CU 183 may be implemented to communicate with the DU 185, as necessary, for network control and signaling.

The DU 185 may correspond to a logical unit that includes one or more base station functions to control the operation of one or more RUs 187. In some aspects, the DU 185 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 185 may further host one or more low PHY layers. Each layer (or module) may be implemented with an interface configured to communicate signals with other layers (and modules) hosted by the DU 185, or with the control functions hosted by the CU 183.

Lower-layer functionality may be implemented by one or more RUs 187. In some deployments, an RU 187, controlled by a DU 185, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 187 may be implemented to handle over the air (OTA) communication with one or more UEs 104. In some implementations, real-time and non-real-time aspects of control and user plane communication with the RU(s) 187 may be controlled by the corresponding DU 185. In some scenarios, this configuration may enable the DU(s) 185 and the CU 183 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements, which may be managed via an operations and maintenance interface (such as an O1 interface). For virtualized network elements, the SMO Framework 105 may be configured to interact with a cloud computing platform (such as an open cloud (O-Cloud) 189) to perform network element life cycle management (such as to instantiate virtualized network elements) via a cloud computing platform interface (such as an O2 interface). Such virtualized network elements may include, but are not limited to, CUs 183, DUs 185, RUs 187 and Near-RT RICs 125. In some implementations, the SMO Framework 105 may communicate with a hardware aspect of a 4G RAN, such as an open eNB (O-eNB) 111, via an O1 interface. Additionally, in some implementations, the SMO Framework 105 may communicate directly with one or more RUs 187 via an O1 interface. The SMO Framework 105 also may include the Non-RT RIC 115 configured to support functionality of the SMO Framework 105.

The Non-RT RIC 115 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 183, one or more DUs 185, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

The concepts and various aspects described herein may be applicable to vehicle-to-everything (V2X) or other similar areas, such as D2D communication, IoT communication, Industrial IoT (IIoT) communication, and/or other standards/protocols for communication in wireless/access networks. Additionally or alternatively, the concepts and various aspects described herein may be applicable to vehicle-to-pedestrian (V2P) communication, pedestrian-to-vehicle (P2V) communication, vehicle-to-infrastructure (V2I) communication, and/or other frameworks/models for communication in wireless/access networks. Additionally, the concepts and various aspects described herein may be applicable to NR or other similar areas, such as LTE, LTE-Advanced (LTE-A), Code Division Multiple Access (CDMA), Global System for Mobile communications (GSM), or other wireless/radio access technologies. Additionally, the concepts and various aspects described herein may be applicable for use in aggregated or disaggregated base station architectures, such as Open-Radio Access Network (O-RAN) architectures.

Certain aspects and techniques as described herein may be implemented, at least in part, using an artificial intelligence (AI) program, such as a program that includes a machine learning (ML) or artificial neural network (ANN) model. An example ML model may include mathematical representations or define computing capabilities for making inferences from input data based on patterns or relationships identified in the input data. As used herein, the term “inferences” can include one or more of decisions, predictions, determinations, or values, which may represent outputs of the ML model. The computing capabilities may be defined in terms of certain parameters of the ML model, such as weights and biases. Weights may indicate relationships between certain input data and certain outputs of the ML model, and biases are offsets which may indicate a starting point for outputs of the ML model. An example ML model operating on input data may start at an initial output based on the biases and then update its output based on a combination of the input data and the weights.

In some aspects, an ML model may be configured to provide computing capabilities for wireless communications. Such an ML model may be configured with weights and biases to improve sidelink power savings in connection with partial sensing. Thus, during operation of a device, the ML model may receive input data, such as UE system state information or partial sensing RRC parameters, and make inferences, such as optimized partial sensing parameter values, based on the weights and biases.

ML models may be deployed in one or more devices, for example, network entities and UEs, and may be configured to enhance various aspects of a wireless communication system. For example, an ML model may be trained to identify patterns or relationships in data corresponding to a network, a device, an air interface, or the like. An ML model may support operational decisions relating to one or more aspects associated with wireless communications devices, networks, or services. For example, an ML model may be utilized for supporting or improving aspects such as signal coding/decoding, network routing, energy conservation, transceiver circuitry controls, frequency synchronization, timing synchronization, channel state estimation, channel equalization, channel state feedback, modulation, demodulation, device positioning, beamforming, load balancing, operations and management functions, security, and the like.

ML models may be characterized in terms of types of learning that generate specific types of learned models that perform specific types of tasks. For example, different types of machine learning include supervised learning, unsupervised learning, semi-supervised learning, reinforcement learning, etc. ML models may be used to perform different tasks such as classification or regression, where classification refers to determining one or more discrete output values from a set of predefined output values, and regression refers to determining continuous values which are not bounded by predefined output values. Some example ML models configured for performing such tasks include ANNs such as convolutional neural networks (CNNs) and recurrent neural networks (RNNs), transformers, diffusion models, regression analysis models (such as statistical models), large language models (LLMs), decision tree learning (such as predictive models), support vector networks (SVMs), probabilistic graphical models (such as a Bayesian network), and the like.

The description herein illustrates, by way of some examples, how one or more tasks or problems in wireless communications may benefit from the application of one or more ML models to enhance sidelink power savings in partial sensing. To facilitate the discussion, an ML model configured using an ANN is used, but it should be understood, that other types of ML models may be used instead of an ANN. Hence, unless expressly recited, subject matter regarding an ML model is not necessarily intended to be limited to an ANN solution. Further, it should be understood that, unless otherwise specifically stated, terms such as “inference model”, “advanced inference model”, “AI/ML model,” “ML model,” “trained ML model,” “ANN, “model,” “algorithm,” or the like are intended to be interchangeable.

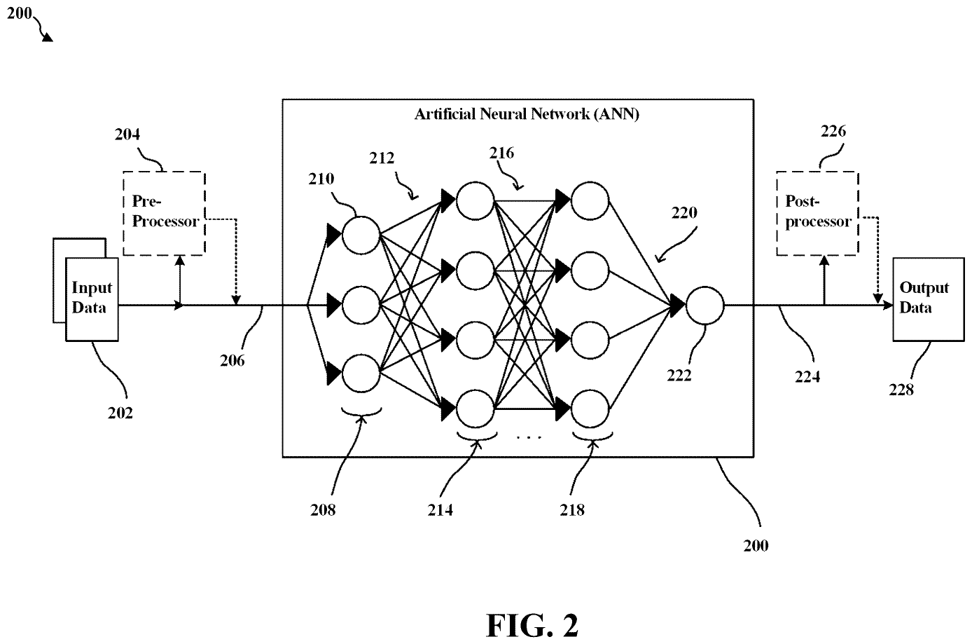

FIG. 2 is an illustrative block diagram of an example machine learning (ML) model represented by an artificial neural network (ANN) 200. ANN 200 may receive input data 206 which may include one or more bits of data 202, pre-processed data output from pre-processor 204 (optional), or some combination thereof. Here, data 202 may include training data, verification data, application-related data, or the like, based, for example, on the stage of deployment of ANN 200. Pre-processor 204 may be included within ANN 200 in some other implementations. Pre-processor 204 may, for example, process all or a portion of data 202 which may result in some of data 202 being changed, replaced, deleted, etc. In some implementations, pre-processor 204 may add additional data to data 202. In some implementations, the pre-processor 204 may be a ML model, such as an ANN.

ANN 200 includes at least one first layer 208 of artificial neurons 210 to process input data 206 and provide resulting first layer data via connections or “edges” such as edges 212 to at least a portion of at least one second layer 214. Second layer 214 processes data received via edges 212 and provides second layer output data via edges 216 to at least a portion of at least one third layer 218. Third layer 218 processes data received via edges 216 and provides third layer output data via edges 220 to at least a portion of a final layer 222 including one or more neurons to provide output data 224. All or part of output data 224 may be further processed in some manner by (optional) post-processor 226. Thus, in certain examples, ANN 200 may provide output data 228 that is based on output data 224, post-processed data output from post-processor 226, or some combination thereof.

Post-processor 226 may be included within ANN 200 in some other implementations. Post-processor 226 may, for example, process all or a portion of output data 224 which may result in output data 228 being different, at least in part, to output data 224, as result of data being changed, replaced, deleted, or the like. In some implementations, post-processor 226 may be configured to add additional data to output data 224. In this example, second layer 214 and third layer 218 represent intermediate or hidden layers that may be arranged in a hierarchical or other like structure. Although not explicitly shown, there may be one or more further intermediate layers between the second layer 214 and the third layer 218. In some implementations, the post-processor 226 may be a ML model, such as an ANN.

The structure and training of artificial neurons 210 in the various layers may be tailored to specific requirements of an application. Within a given layer such as first layer 208, second layer 214, or third layer 218 of ANN 200, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to parameters such as the previously described weights and biases of ANN 200. The weights and biases of ANN 200 may be adjusted during a training process or during operation of ANN 200. The weights of the various artificial neurons may control a strength of connections between layers or artificial neurons, while the biases may control a direction of connections between the layers or artificial neurons. An activation function may select or determine whether an artificial neuron transmits its output to the next layer or not in response to its received data.

Different activation functions may be used to model different types of non-linear relationships. By introducing non-linearity into an ML model, an activation function allows the configuration for the ML model to change in response to identifying or detecting complex patterns and relationships in the input data 206. Some non-exhaustive example activation functions include a sigmoid based activation function, a hyperbolic tangent (tanh) based activation function, a convolutional activation function, up-sampling, pooling, and a rectified linear unit (ReLU) based activation function.

Training of an ML model, such as ANN 200, may be conducted using training data. Training data may include one or more datasets which ANN 200 may use to identify patterns or relationships. Training data may represent various types of information, including written, visual, audio, environmental context, operational properties, etc. During training, the parameters (such as the weights and biases) of artificial neurons 210 may be changed, such as to minimize or otherwise reduce a loss function or a cost function. A training process may be repeated multiple times to fine-tune ANN 200 with each iteration.

ANN 200 or other ML models may be implemented in various types of processing circuits along with memory and applicable instructions therein. For example, general-purpose hardware circuits, such as, such as one or more central processing units (CPUs), one or more graphics processing units (GPUs), or suitable combinations thereof, may be employed to implement a model. In some implementations, one or more tensor processing units (TPUs), neural processing units (NPUs), or other special-purpose processors, field-programmable gate arrays (FPGAs), application-specific integrated circuits (ASICs), or the like may also be employed.

In example aspects, an ML model may be trained prior to, or at some point following, operation of the ML model, such as ANN 200, on input data. When training the ML model, information in the form of applicable training data may be gathered or otherwise created for use in training an ANN accordingly. For example, training data may be gathered or otherwise created regarding information associated with received/transmitted signal strengths, interference, and resource usage data, as well as any other relevant data that might be useful for training a model to address one or more problems or issues in a communication system. In certain instances, all or part of the training data may originate in a user equipment (UE) or other device in a wireless communication system, or one or more network entities, or aggregated from multiple sources (such as a UE and a network entity/entities, one or more other UEs, the Internet, or the like). In another example, training data may be generated or collected online, offline, or both online and offline by a UE, network entity, or other device(s), and all or part of such training data may be transferred or shared (in real or near-real time), such as through store and forward functions or the like.

Once an ANN has been configured by setting parameters, including weights and biases, from training data, the ANN's performance may be evaluated. In some scenarios, evaluation/verification tests may use a validation dataset, which may include data not in the training data, to compare the model's performance to baseline or other benchmark information. The ANN configuration may be further refined, for example, by changing its architecture, re-training it on the data, using different optimization techniques, or the like.

As part of a training process, parameters affecting the functioning of the artificial neurons and layers may be adjusted. For example, backpropagation techniques may be used to train an ANN by iteratively adjusting weights or biases of certain artificial neurons associated with errors between a predicted output of the model and a desired output that may be known or otherwise deemed acceptable. Backpropagation may include a forward pass, a loss function, a backward pass, and a parameter update that may be performed in training iteration. The process may be repeated for a certain number of iterations for each set of training data until the weights of the artificial neurons/layers are adequately tuned.

Backpropagation techniques associated with a loss function may measure how well a model is able to predict a desired output for a given input. An optimization algorithm may be used during a training process to adjust weights and biases as needed to reduce or minimize the loss function which should improve the performance of the model. There are a variety of optimization algorithms that may be used along with backpropagation techniques or other training techniques. Some initial examples include a gradient descent based optimization algorithm and a stochastic gradient descent based optimization algorithm. A stochastic gradient descent technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases.

In some implementations, one or more devices or services may support processes relating to a ML model's usage, maintenance, activation, reporting, or the like. In certain instances, all or part of a dataset or model may be shared across multiple devices, to provide or otherwise augment or improve processing. In some examples, signaling mechanisms may be utilized at various nodes of wireless network to signal the capabilities for performing specific functions related to ML model, support for specific ML models, capabilities for gathering, creating, transmitting training data, or other ML related capabilities. ML models in wireless communication systems may, for example, be employed to support decisions or improve performance relating to wireless resource allocation or selection, wireless channel condition estimation, interference mitigation, beam management, positioning accuracy, energy savings, or modulation or coding schemes, etc. In some implementations, model deployment may occur jointly or separately at various network levels, such as, a UE, a network entity such as a base station, or a disaggregated network entity such as a central unit (CU), a distributed unit (DU), a radio unit (RU), or the like.

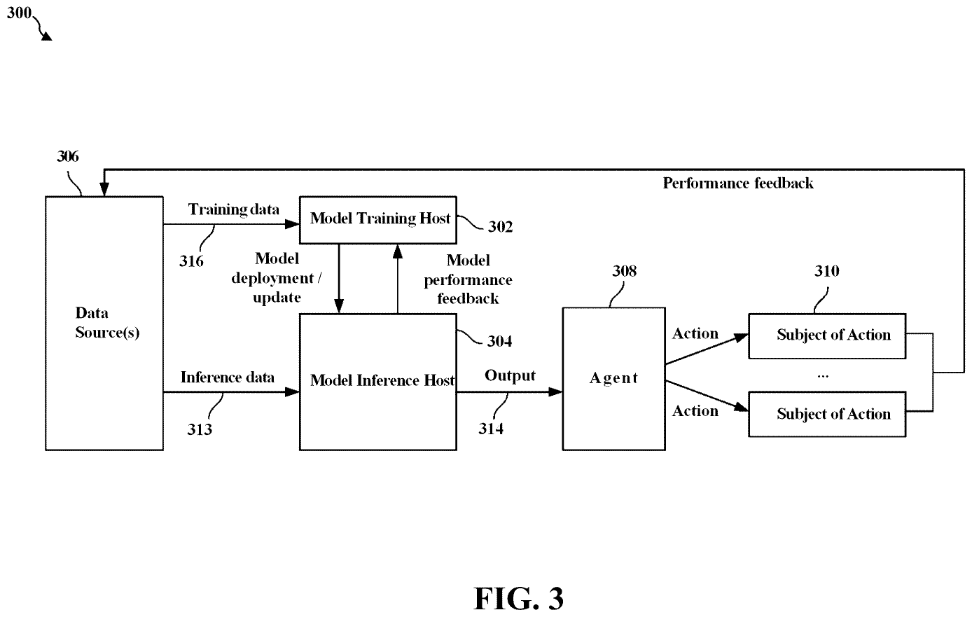

FIG. 3 is an illustrative block diagram of an example ML architecture 300 that may be used for wireless communications in any of the various implementations, processes, environments, networks, or use cases listed above. As illustrated, architecture 300 includes multiple logical entities, such as model training host 302, model inference host 304, data source(s) 306, and agent 308. Model inference host 304 is configured to run an ML model based on inference data 312 provided by data source(s) 306. Model inference host 304 may produce output 314, which may include a prediction or inference, such as a discrete or continuous value based on inference data 312, which may then be provided as input to the agent 308.

Agent 308 may represent an element or an entity of a wireless communication system including, for example, a radio access network (RAN), a wireless local area network, a device-to-device (D2D) communications system, or the like. As an example, agent 308 may be a user equipment such as UE 104, a base station such as base station 102/180, or a disaggregated network entity such as CU 183, DU 185, or RU 187, an access point, a wireless station, or a RAN intelligent controller (RIC) in a cloud-based RAN, among some examples. Additionally, agent 308 also may be a type of agent that depends on the type of tasks performed by model inference host 304, the type of inference data 312 provided to model inference host 304, or the type of output 314 produced by model inference host 304.

Agent 308 may perform one or more actions associated with receiving output 314 from model inference host 304. For example, if agent 308 is a UE and the output 314 from model inference host are RRC parameters for sidelink partial sensing, agent 308 may apply partial sensing in mode 2 resource allocation using these parameters. Agent 308 may indicate the one or more actions performed to at least one subject of action 310. For example, if the agent 308 determines to perform sidelink communication between agent 308 and the subject of action 310 such as a UE, agent 308 may apply partial sensing using the output 314 from model inference host 304 to reserve resources for communication with the subject of action 310 such as the other UE. In some cases, agent 308 and the subject of action 310 are the same entity.

Data can be collected from data sources 306, and may be used as training data 316 for training an ML model, or as inference data 312 for feeding an ML model inference operation. Data sources 306 may collect data from various subject of action 310 entities such as, the UE or the network entity, and provide the collected data to a model training host 302 for ML model training. For example, after a subject of action 310 such as another UE receives a sidelink communication from agent 308, the subject of action 310 may provide performance feedback associated with the sidelink communication such as measurements to the data sources 306. The performance feedback may be used by the model training host 302 for monitoring or evaluating the ML model performance. In some examples, if output 314 provided to agent 308 is inaccurate (or the accuracy is below an accuracy threshold), model training host 302 may provide feedback to model inference host 304 to modify or retrain the ML model used by model inference host 304, such as via an ML model deployment update.

Model training host 302 may be deployed at the same or a different entity than that in which model inference host 304 is deployed. For example, in order to offload model training processing, which can impact the performance of model inference host 304, model training host 302 may be deployed at a model server.

Referring to FIGS. 1A and 1B, in certain aspects, the UE 104 may include a partial sensing UE component 198 that is configured to obtain, from a network entity, a RRC configuration including a sidelink information element indicating a sidelink parameter for partial sensing; select, using the partial sensing, a resource from a resource pool for sidelink communication, the partial sensing being based at least in part on a UE inference model at the apparatus or a network inference model at the network entity; and send data in the selected resource. The network entity may be, for example, base station 102/180, disaggregated base station 181, a component of disaggregated base station 181 such as CU 183, DU 185, or RU 187, or some other network node. In some other aspects, an ML model is deployed at or on a UE such as UE 104 for optimizing and enhancing sidelink power savings. More specifically, a model inference host, such as model inference host 304 in FIG. 3, may be deployed at or on the UE for fine tuning partial sensing parameters obtained from the network entity to be applied in mode 2 resource allocation.

Furthermore, in certain aspects, a network entity such as base station 102/180, disaggregated base station 181, or a component of disaggregated base station 181 such as CU 183, DU 185, or RU 187, may include a partial sensing network (NW) component 199 that is configured to obtain information associated with sidelink communication, the sidelink communication being in a selected resource from a resource pool; and send to a UE, in response to the information, a RRC configuration including a sidelink information element indicating a sidelink parameter for partial sensing, the partial sensing being based at least in part on a UE inference model at the UE or a network inference model at the apparatus. In some aspects, an ML model is deployed at or on a network entity such as BS 102/180 for optimizing and enhancing sidelink power savings. More specifically, a model interference host, such as model inference host 304 in FIG. 3, may be deployed at or on the network entity to produce partial sensing parameters for a UE to apply in mode 2 resource allocation.

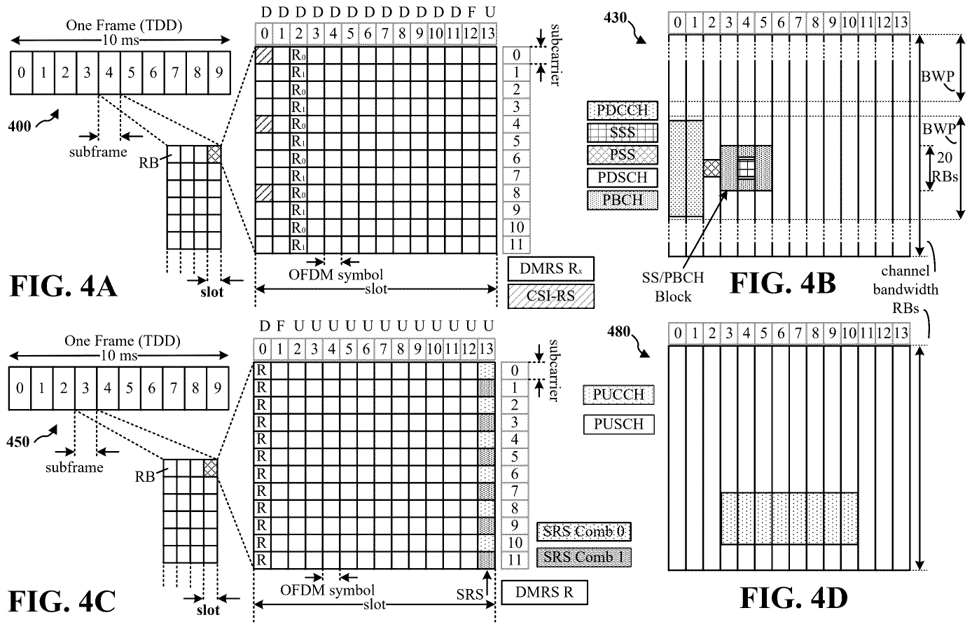

FIG. 4A is a diagram 400 illustrating an example of a first subframe within a 5G NR frame structure. FIG. 4B is a diagram 430 illustrating an example of DL channels within a 5G NR subframe. FIG. 4C is a diagram 450 illustrating an example of a second subframe within a 5G NR frame structure. FIG. 4D is a diagram 480 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 4A, 4C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 4A-4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 4B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for the UE. The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 4B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 4C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data and may additionally be used to carry a buffer status report (BSR), a power headroom report (PHR), and/or UCI.

FIG. 5 illustrates example diagrams 500 and 510 illustrating example slot structures that may be used for wireless communication between UE 104 and UE 104′, e.g., for sidelink communication. The slot structure may be within a 5G/NR frame structure. Although the following description may be focused on 5G NR, the concepts described herein may be applicable to other similar areas, such as LTE, LTE-A, CDMA, GSM, and other wireless technologies. This is merely one example, and other wireless communication technologies may have a different frame structure and/or different channels. A frame (10 ms) may be divided into 10 equally sized subframes (1 ms). Each subframe may include one or more time slots. Subframes may also include mini-slots, which may include, for example, 7, 4, or 2 symbols. Each slot may include 7 or 14 symbols, depending on the slot configuration. For slot configuration 0, each slot may include 14 symbols, and for slot configuration 1, each slot may include 7 symbols. Diagram 500 illustrates a single slot transmission, e.g., which may correspond to a 0.5 ms transmission time interval (TTI). Diagram 510 illustrates an example two-slot aggregation, e.g., an aggregation of two 0.5 ms TTIs. Diagram 500 illustrates a single RB, whereas diagram 510 illustrates N RBs. In diagram 510, 10 RBs being used for control is merely one example. The number of RBs may differ.

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 5, some of the REs may comprise control information, e.g., along with demodulation RS (DMRS). FIG. 5 also illustrates that symbol(s) may comprise CSI-RS. The symbols in FIG. 5 that are indicated for DMRS or CSI-RS indicate that the symbol comprises DMRS or CSI-RS REs. Such symbols may also comprise REs that include data. For example, if a number of ports for DMRS or CSI-RS is 1 and a comb-2 pattern is used for DMRS/CSI-RS, then half of the REs may comprise the RS and the other half of the REs may comprise data. A CSI-RS resource may start at any symbol of a slot, and may occupy 1, 2, or 4 symbols depending on a configured number of ports. CSI-RS can be periodic, semi-persistent, or aperiodic (e.g., based on DCI triggering). For time/frequency tracking, CSI-RS may be either periodic or aperiodic. CSI-RS may be transmitted in busts of two or four symbols that are spread across one or two slots. The control information may comprise Sidelink Control Information (SCI). At least one symbol may be used for feedback, as described herein. A symbol prior to and/or after the feedback may be used for turnaround between reception of data and transmission of the feedback. Although symbol 12 is illustrated for data, it may instead be a gap symbol to enable turnaround for feedback in symbol 13. Another symbol, e.g., at the end of the slot may be used as a gap. The gap enables a device to switch from operating as a transmitting device to prepare to operate as a receiving device, e.g., in the following slot. Data may be transmitted in the remaining REs, as illustrated. The data may comprise the data message described herein. The position of any of the SCI, feedback, and LBT symbols may be different than the example illustrated in FIG. 5. Multiple slots may be aggregated together. FIG. 5 also illustrates an example aggregation of two slot. The aggregated number of slots may also be larger than two. When slots are aggregated, the symbols used for feedback and/or a gap symbol may be different that for a single slot. While feedback is not illustrated for the aggregated example, symbol(s) in a multiple slot aggregation may also be allocated for feedback, as illustrated in the one slot example.

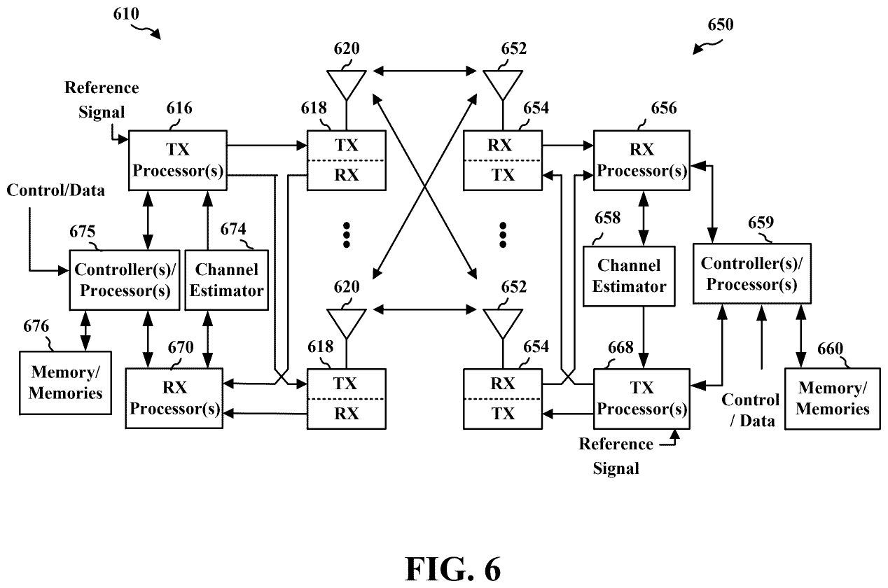

FIG. 6 is a block diagram of a base station 610 in communication with a UE 650 in an access network. In the DL, IP packets from the EPC 160 may be provided to one or more controllers/processors 675. The one or more controllers/processors 675 implement layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The one or more controllers/processors 675 provide RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The one or more transmit (TX) processors 616 and the one or more receive (RX) processors 670 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The one or more TX processors 616 handle mapping to signal constellations based on various modulation and coding schemes (MCS) (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream may then be provided to a different antenna 620 via a separate transmitter 618TX. Each transmitter 618TX may modulate an RF carrier with a respective spatial stream for transmission.

At the UE 650, each receiver 654RX receives a signal through its respective antenna 652. Each receiver 654RX recovers information modulated onto an RF carrier and provides the information to the one or more receive (RX) processors 656. The one or more TX processors 668 and the one or more RX processors 656 implement layer 1 functionality associated with various signal processing functions. The one or more RX processors 656 may perform spatial processing on the information to recover any spatial streams destined for the UE 650. If multiple spatial streams are destined for the UE 650, they may be combined by the one or more RX processors 656 into a single OFDM symbol stream. The one or more RX processors 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 610. These soft decisions may be based on channel estimates computed by the channel estimator 658. The soft decisions are then decoded and deinterleaved to recover the data and control signals that were originally transmitted by the base station 610 on the physical channel. The data and control signals are then provided to the one or more controllers/processors 659, which implement layer 3 and layer 2 functionality.

The one or more controllers/processors 659 may each be associated with one or more memories 660 that store program codes and data. The one or more memories 660, individually or in any combination, may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). In the UL, the one or more controllers/processors 659 provide demultiplexing between transport and logical channels, packet reassembly, deciphering, header decompression, and control signal processing to recover IP packets from the EPC 160. The one or more controllers/processors 659 are also responsible for error detection using an ACK and/or NACK protocol to support HARQ operations.

Similar to the functionality described in connection with the DL transmission by the base station 610, the one or more controllers/processors 659 provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 658 from a reference signal or feedback transmitted by the base station 610 may be used by the one or more TX processors 668 to select the appropriate coding and modulation schemes, and to facilitate spatial processing. The spatial streams generated by the one or more TX processors 668 may be provided to different antenna 652 via separate transmitters 654TX. Each transmitter 654TX may modulate an RF carrier with a respective spatial stream for transmission.

The UL transmission is processed at the base station 610 in a manner similar to that described in connection with the receiver function at the UE 650. Each receiver 618RX receives a signal through its respective antenna 620. Each receiver 618RX recovers information modulated onto an RF carrier and provides the information to one or more RX processors 670.

The one or more controllers/processors 675 may each be associated with one or more memories 676 that store program codes and data. The one or more memories 676, individually or in any combination, may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). In the UL, the one or more controllers/processors 675 provide demultiplexing between transport and logical channels, packet reassembly, deciphering, header decompression, control signal processing to recover IP packets from the UE 650. IP packets from the one or more controllers/processors 675 may be provided to the EPC 160. The one or more controllers/processors 675 are also responsible for error detection using an ACK and/or NACK protocol to support HARQ operations.

At least one of the one or more TX processors 668, the one or more RX processors 656, and the one or more controllers/processors 659 may be configured to perform aspects in connection with partial sensing UE component 198 of FIG. 1A.

At least one of the one or more TX processors 616, the one or more RX processors 670, and the one or more controller/processors 675 may be configured to perform aspects in connection with partial sensing NW component 199 of FIG. 1A.

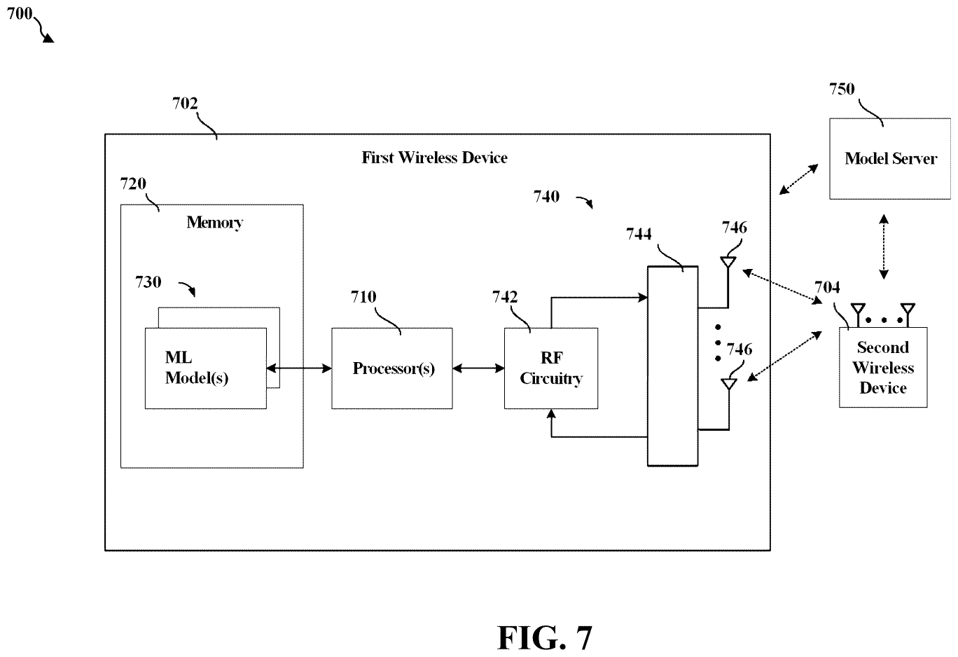

FIG. 7 is an illustrative block diagram of an example ML architecture 700 of a first wireless device 702 in communication with a second wireless device 704. In one example, first wireless device 702 may correspond to the UE 104, 650, while second wireless device 704 may correspond to base station 102/180, 610. In another example, first wireless device 702 may correspond to the base station 102/180, 610, while second wireless device 704 may correspond to the UE 104, 650. Note that the example ML architecture of first wireless device 702 may be applied to second wireless device 704, and vice versa.

First wireless device 702 may be, or may include, a chip, system on chip (SoC), chipset, package or device that includes one or more processors, processing blocks or processing elements, collectively processor 710, and one or more memory blocks or elements, collectively memory 720. Processor 710 may correspond to at least one of the one or more TX processors 668, the one or more RX processors 656, or the one or more controllers/processors 659, or at least one of the one or more TX processors 616, the one or more RX processors 670, or the one or more controller/processors 675. Memory 720 may correspond to the one or more memories 676 or 660. Processor 710 may be coupled to transceiver 740, which includes radio frequency (RF) circuitry 742 coupled to antennas 746 via interface 744, for transmitting or receiving signals. Antennas 746 may correspond to antennas 620 or 652.

One or more ML models 730, collectively ML model 730, may be stored in memory 720 and accessible to processor(s) 710. Individual or groups of ML models 730 may be associated with respective model identifiers. In some aspects, different ML models 730, which may optionally be associated with different model identifiers, may have different characteristics. One or more ML models 730 may be selected based on respective features, characteristics, or applications, as well as characteristics or conditions of first wireless device 702, such as, a power state, a mobility state, a battery reserve, a temperature, or the like. For example, ML models 730 may have different inference data and output pairings, such as different types of inference data that produce different types of output, different levels of accuracies associated with the predictions, different latencies associated with producing the predictions, different ML model sizes, different coefficients, different parameters, or the like.

Processor 710 may deploy ML models 730 to produce respective output data based on input data. As an example, the ML model 730 may take UE system state information or partial sensing RRC parameters as input to produce optimized partial sensing parameter values as output. In some aspects, model server 750 may perform various ML management tasks for first wireless device 702, second wireless device 704, or both wireless devices.

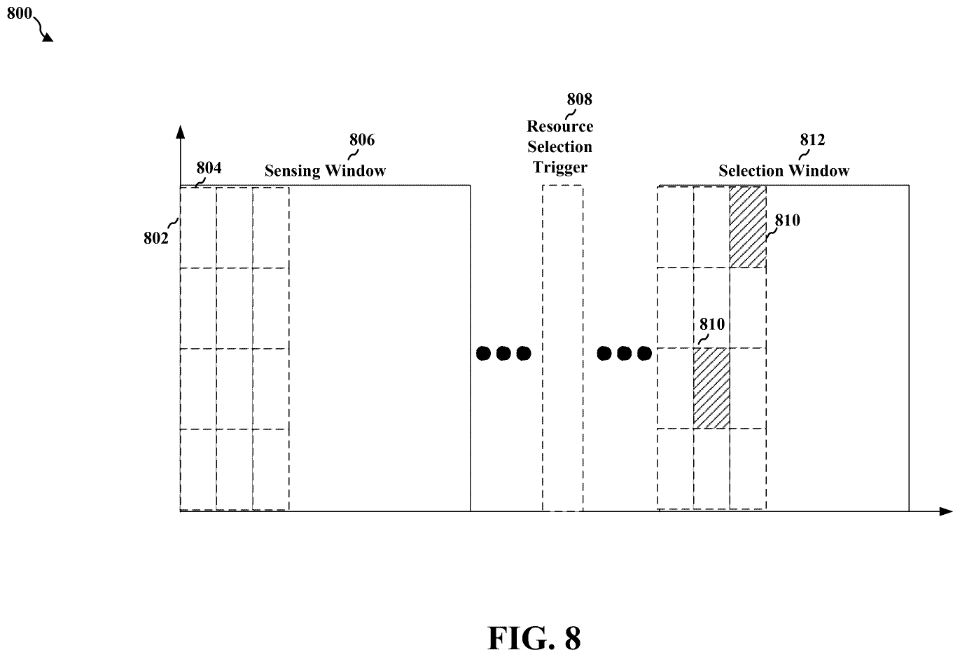

FIG. 8 illustrates an example of a sidelink resource pool 800 in NR V2X, where sidelink transmissions or receptions may occur. Resource pool 800 may be a set of available resources configured by higher layers of a UE for transmission and reception of PSCCH or PSSCH. For instance, the resource grids illustrated in FIG. 5 may be part of a resource pool. Resource pool 800 may include a set of contiguous subchannels 802 in the frequency domain and a number of slots 804 in the time domain. A subchannel includes multiple RBs, respectively including 12 consecutive subcarriers.

The resource pool 800 may be associated with one of multiple resource allocation modes for sidelink communication. In mode 1 resource allocation, the base station 102 may schedule sidelink resources in the resource pool for the UE 104 to use in sidelink transmissions and receptions. This mode may apply to UEs 104 in coverage of the base station 102. In mode 2 resource allocation, the UE 104 may autonomously select sidelink transmission resources within the resource pool 800 to use for sidelink transmissions and receptions. This mode may apply to UEs in coverage and out-of-coverage (OoC) of the base station. OoC UEs may include those having limited or no network coverage and thus which may not reliably or cannot connect to the gNB, although they may still be able to reliably connect to a satellite or to each other.

In certain scenarios including OoC scenarios, it is beneficial for UEs to communicate with one another over sidelink autonomously, that is, under a mode 2 resource allocation, while having some degree of control from the network if possible. For instance, the network may configure UEs with a bandwidth part and other RRC parameters for mode 2 operation but avoid scheduling resources for each of the D2D UEs. Instead, the RAN entity may ask UEs to apply mode 2 resource allocation, which is UE managed or autonomous instead of mode 1 resource allocation.

This allows the RAN entity such as base station 102 to service non-D2D users and save network power by eliminating the need to schedule sidelink resources. For instance, in UAV communication, UAVs may operate in the sky, and therefore if a base station has to frequently communicate with a swarm of UAVs to provide resources under mode 1 resource allocation, then the base station would point towards the sky and thus be unable to serve terrestrial UEs. Moreover, in massive IIoT operations, the RAN node may not be computationally able to schedule UEs individually, since the base station may end up having to communicate with a significant number of UEs to coordinate fire detection or other public safety operations. In such cases, including but not limited to terrestrial UEs or emergency or rapidly developing situations, it may be difficult for a base station to schedule UEs under mode 1 resource allocation. Therefore, even during in coverage scenarios where constantly interacting UEs may have network coverage, it may be beneficial for UEs to communicate with each other autonomously via sensing and resource selection under mode 2. Moreover, during mode 2 resource allocation, the network may still control the UEs, such as a UAV swarm or cluster of IIoTs from time to time and gather information such as data from the UEs to facilitate its control of these UEs. For instance, the RAN entity or network may periodically collect data and key performance indicators (KPIs) from sidelink UEs and update configuration parameters for these UEs accordingly.

However, when sidelink UEs operate in an OoC mode or during OoC scenarios, these UEs still operate on a licensed band. Therefore, in the absence of gNB scheduling to control these UEs, the UEs sense the channel before transmitting. The UEs continuously sense the sidelink channel and decode sidelink control information (SCI) to identify reserved resources for transmission. The SCI may include the current resource on which the UE is going to transmit the control information and some future resources on which the UE plans to transmit. By decoding and aggregating SCI, sidelink UEs may determine the potentially available resources in resource pool 800, or in some other set of configured time-frequency resources.

For instance, referring again to FIG. 8, to reserve resources for sidelink transmission in mode 2 resource allocation, the UE 104 may apply a resource sensing and selection procedure. This procedure includes sensing and resource selection. During sensing, the UE may identify candidate resources for resource selection within a sensing window 806. The candidate resources may be identified based on decoding of SCI and reference signal received power (RSRP) measurements from nearby UEs. During selection, following a resource selection trigger 808 by higher layers, the UE 104 may select for sidelink transmission a subset of identified candidate resources 810 in a resource selection window 812. The subset may be identified based on SCIs, RSRP measurements, and a percentage of total resources within the resource selection window.

Such sensing of the sidelink channel is helpful as sidelink transmission may rely on collision avoidance based on transmitter side resource exclusion. When a UE transmits data, it looks at the information it has gathered from continuous sensing of the sidelink channel and determines the resources 810 where it determines it has a low probability of collision. With other UEs in the distributed system, there may be a possibility of collision, and so collision avoidance is used as a reliability enhancement along with interference coordination.

Yet, this sensing may be a significant source of power consumption for sidelink UEs. For instance, in the aforementioned resource sensing and selection procedure described with respect to FIG. 8, the UE may perform a full sensing operation in which the UE monitors all sensing occasions within the sensing window 806. Thus, during sensing, the UE may continuously decode the sidelink control channel within the sensing window, which becomes a key cause of power draw for sidelink UEs.

Furthermore, current sidelink designs predominantly focused on C-V2X communications. For 6G, sidelink designs may additionally focus on other D2D communication paradigms. Some of these devices may include industrial IoT devices, unmanned aerial vehicles (UAVs), and the like. These devices may be form factor limited and power limited devices. Since these devices may be even more limited in power than a vehicle, more intelligent power savings mechanisms are desirable to employ at these devices and allow these devices to operate longer with the limited battery they possess.

Accordingly, sidelink power savings has been a main topic for investigation and standardization in 5G. Power savings has been a topic since LTE, as discontinuous reception (DRX) and other advanced features have been implemented for Uu connections or communications to support power conservation at UEs. However, while V2X UEs may perform continuous or full channel sensing at sufficient power consumption levels sufficient at least for V2X use cases, such consumption may not be sufficient at least for low power IoT devices due to their limited battery and form factor.

Thus, further mechanisms have been considered for sidelink power savings in support at least for OOC sidelink communication. One mechanism includes sidelink DRX, which has been extended to encompass sidelink connections, including unicast, groupcast, and broadcast communications. In these sidelink connections, sidelink peers may negotiate a sidelink DRX schedule based on their own traffic intervals.

Another power savings mechanism is sidelink partial sensing. Partial sensing may be applied to reduce sidelink power consumption, specifically the power consumption associated with continuous channel sensing. Partial sensing may reduce power consumption of sidelink UEs operating in an OoC communication mode by reducing the channel sensing the UE performs. This power savings may be accomplished, for example, using random selection, contiguous partial sensing, or periodic-based partial sensing.

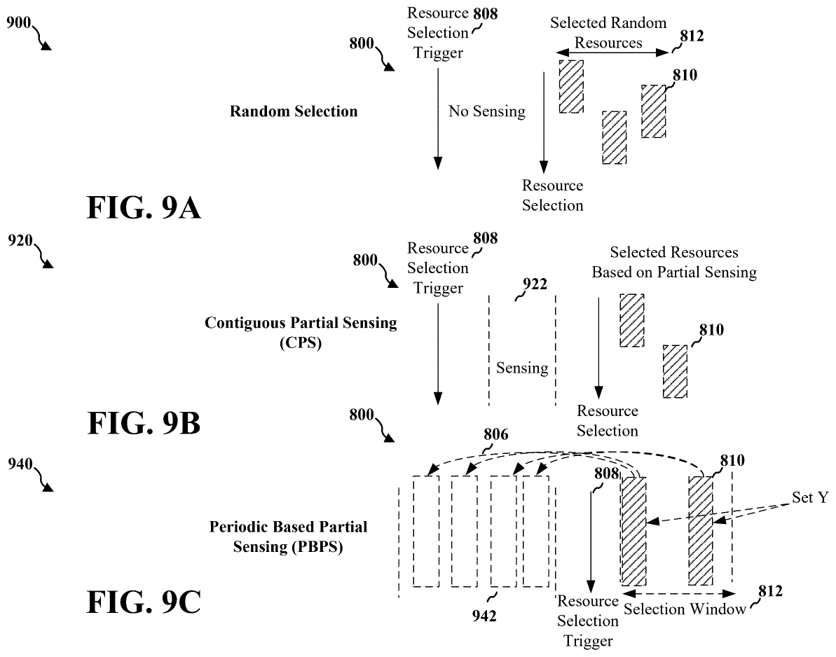

FIGS. 9A-9C illustrate examples 900, 920, 940 of different partial sensing schemes. In particular, FIG. 9A illustrates an example of random selection, FIG. 9B illustrates an example of contiguous partial sensing (CPS), and FIG. 9C illustrates an example of periodic-based partial sensing (PBPS). These partial sensing schemes may be applied, for example, to the resource pool 800 of FIG. 8.

Referring to FIG. 9A, the UE 104 may apply random selection, without sensing, in certain resource pools 800. For instance, for UEs incapable of sensing, the UE may randomly select resources 810 in the selection window 812 without sensing in any resource pool 800. In another example, the UE may randomly select candidates without sensing in resource pools 800 where a UE may not be able to sense resources at least a quantity M slots before transmission. In random selection, the UE receives the resource selection trigger 808 and randomly selects a plurality of resources 810 for transmission without performing sensing. Thus, the collision occurrence may not go beyond a certain probability.

Referring to FIG. 9B, in contiguous partial sensing, the UE 104 may monitor multiple consecutive slots for sidelink resources prior to resource selection. In CPS, the UE does not sense resources until after it receives the resource selection trigger 808. After the trigger occurs, the UE 104 performs sensing in a window 922 of length M slots before transmission. The parameter M has a default value of 31 but may be different in other examples. For instance, the parameter M may be configured with any value within a range between and including 0 and 30 slots. After performing sensing during the sensing window size or M slots, the UE may perform resource selection and select resources 810 based on this limited sensing operation. For instance, the UE may select resources 810 in a set of Y′ candidate slots within the selection window 812.

Referring to FIG. 9C, in PBPS, the UE 104 performs periodic partial sensing in periodic resource reservations. The sensing may be performed at probable periodicities that neighbor UEs are transmitting. When periodic resource reservations are configured for the resource pool 800, the UE monitors a number of sensing occasions 942 within the sensing window 806. The UE monitors the sensing occasions at periodicities configured according to a sidelink resource selection period. Based on the UE's periodic monitoring of these resources and after a resource selection trigger 808 is received from higher layers, the UE may select a plurality of resources 810 from a set of candidate slots Y for transmission in the selection window 812.

Thus, for purposes of this disclosure, partial sensing may include any of random selection, in which the UE does not sense but just selects resources in a given resource pool such as shown in FIG. 9A, contiguous partial sensing, in which the UE senses resources during a short window and then selects resources based on the sensing such as shown in FIG. 9B, or periodic-based partial sensing, in which the UE periodically listens on certain resources to determine if a collision may occur and then transmits in selected resources accordingly such as shown in FIG. 9C. However, partial sensing is not limited to these types. For instance, partial sensing may include full, continuous sensing such as shown in FIG. 8.

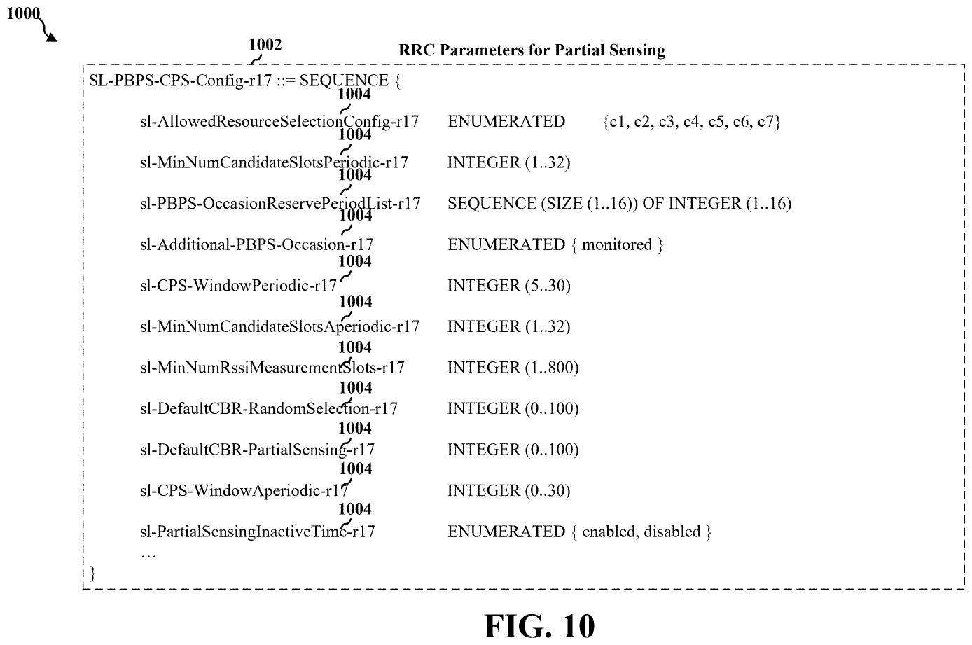

FIG. 10 illustrates an example 1000 of a PBPS and CPS configuration information element (IE 1002) including RRC parameters 1004 associated with partial sensing in sidelink communication. This IE 1002 may specify the operation information for a resource pool such as resource pool 800 which may be configured to enable full sensing only, partial sensing only, random resource selection only, or any combination of the foregoing. The base station 102 may use this IE 1002 to configure a PHY or MAC layer of the UE for random resource selection such as shown in FIG. 9A, periodic based partial sensing such as shown in FIG. 9C, or contiguous based partial sensing such as shown in FIG. 9B.

The configuration may include various parameters 1004 for partial sensing. For example, the IE 1002 may indicate a sidelink allowed resource selection configuration (sl-AllowedResourceSelectionConfig), which notifies the PHY layer or MAC layer of the UE 104 that the UE 104 is to perform random selection, partial sensing, full sensing, or some combination thereof. The allowed resource selection configuration may indicate one of multiple values indicating the allowed resource selection mechanism(s), including c1 (only full sensing allowed), c2 (only partial sensing allowed), c3 (only random selection allowed), c4 (full sensing and random selection allowed), c5 (full sensing and partial sensing allowed), c6 (partial sensing and random selection allowed), and c7 (full sensing and partial sensing and random selection allowed).

The configuration may also include other parameters defining random resource selection, CPS or PBPS operations for the sidelink UE. For instance, the IE 1002 may indicate whether the UE additionally monitors periodic sensing occasions that correspond to a set of values (sl-Additional-PBPS-Occasion), a minimum size M of a CPS window in logical slot units respectively for aperiodic transmission (sl-CPS-WindowAperiodic) and periodic transmission (sl-CPS-WindowPeriodic), a default channel busy ratio measurement value respectively for partial sensing (sl-DefaultCBR-PartialSensing) and random resource selection (sl-DefaultCBR-RandomSelection), a minimum number of candidate slots Y respectively for aperiodic transmission (sl-MinNumCandidateSlotsAperiodic) and periodic transmission (sl-MinNumCandidateSlotsPeriodic), a threshold for a minimum number of received signal strength indicator measurement slots (sl-MinNumRssiMeasurementSlots), whether the UE is required to perform sidelink reception of PSCCH and RSRP measurement for partial sensing on slots in a sidelink DRX inactive time (sl-PartialSensingInactiveTime), a subset of periodicity values from a set of possible resource reservation periods used to determine periodic sensing occasions in PBPS (sl-PBPS-OccasionReservePeriodList), or any combination of the foregoing.

In various aspects of the present disclosure, one or more of the network or sidelink UE may apply native inference (AI/ML) models to at least the aforementioned RRC parameters related to partial sensing to improve native partial sensing operations and thus to optimize or enhance sidelink power savings. For instance, when the sidelink PHY layer of UE 104 applies partial sensing to reduce power consumption by reducing channel sensing operations, an inference model at the UE or network's model inference host 304 such as ANN 200 or ML model 730 may be applied to optimize or enhance the partial sensing operation. For example, the network entity or base station 102 as agent 308 may determine via its inference model a set of parameters that may reduce power consumption of UAV swarms, while individual UEs as agents 308 may fine tune these parameters via their respective inference model(s) to trade off communication and device energy efficiency, including device energy consumption metrics and the like. In one example, referring to the RRC parameters of FIG. 10, the UE 104 may originally be indicated to apply full, continuous sensing based on the sidelink allowed resource selection configuration parameter (sl-AllowedResourceSelectionConfig), and its inference model may then indicate the UE 104 to switch from full sensing to partial sensing, including random selection, CPS, or PBPS. Energy cost may be considered a parameter that may be applied as a performance indicator for the ML model 730. Thus, inference models present at one or both the network and edge devices such as UEs 104 may be leveraged to achieve energy-efficient, or green, sidelink communication.

The inference model of the UE 104 or base station 102 or both may output parameters for sidelink sensing, such as the RRC parameters of FIG. 10 for partial sensing, based on inputs to the model. For instance, a value for the allowed resource selection configuration parameter or other RRC parameter(s) of FIG. 10, an energy cost KPI, or other factor(s) may be input to the UE's or base station's ML model 730 at model inference host 304. Weights and biases may also be applied to the inputs in the model. Then, based on these inputs, the inference model may output a same or different value for the allowed resource selection configuration parameter or other RRC parameter(s) of FIG. 10. The UE or base station may then apply the partial sensing parameters output or produced from the model for more efficient sidelink communication.

The inference model may be a neural network or a non-neural network. For instance, the inference model may be a linear regression model, a large language model (LLM), a recursive neural network (RNN)-based reinforcement learning model, or some other model. For instance, the inference model may apply reinforcement learning in which a particular set of resources in a bandwidth is input to the model and same or different partial sensing parameters are output in response to these inputs. Alternatively, other learning techniques may be applied. For example, the inference model may include or be part of an expert learning system in which the network provides information to the model, such as values of partial sensing RRC parameters, and the model applies a local learning technique to refine these parameters at the UE. Data to be input into the model may be collected on the fly, for example in real-time. Alternatively, collected data may be stored and input into the model in non-real time. The inference model may be trained, for example, using a digital twin model or a ray tracing model or the like, and inferences may be made from the neural network or other model based on collected data and KPIs. These or other AI/ML technologies may alternatively or additionally be used for inference model training or inference production.

In addition to producing partial sensing parameters for sidelink communication, the inference model may output KPIs such as an energy cost associated with these partial sensing parameters. The energy cost or other performance indicators output from the model may be utilized to improve the inference model. For example, the energy cost may be compared to a loss function, and if the result of the loss function is not minimized or otherwise sub-optimal, the model or its associated parameters may be adjusted. For example, weights applied to these different inputs of a neural network-based inference model may be modified to control and change the output(s) of the inference model. The model may be refined until a lowest or otherwise optimal energy cost incurred from sidelink communication using mode 2 resource allocation is achieved.

In one aspect, a sidelink UE such as UE 104 may rely on its own inference model to determine parameters for partial sensing. The partial sensing parameters may be based on UE characteristics or preconfigured or configured parameters in combination with an inference model at the UE or edge device itself. For instance, UE characteristics or parameters may be input into the inference model of the UE to produce partial sensing parameters. Examples of parameters input to the UE's model may include, for example, the RRC partial sensing parameters of FIG. 10. Examples of UE characteristics input to the UE's model may include one or more KPIs, such as, for example, how the UE's battery is behaving, what is the UE's traffic pattern, or the like. For instance, the inference model may consider one or more KPIs to provide long term benefits with respect to energy consumption in partial sensing. For instance, the inference model may generate sidelink partial sensing parameters based on past and predicted energy consumption per bit in Joules-per-bit. This metric may be one input into the inference model used to generate partial sensing parameters. For example, the model may determine partial sensing parameters based on a time series of past energy consumption or based on predicted energy consumption interpolated or otherwise derived from this time series. The inference model may also be trained and produce inferences based on other KPIs to ensure data rate reliability, latency optimization targets and budgets, or a combination of these or other factors. For instance, along with energy consumption factors, the inference model may generate a set of partial sensing parameters based on a reliability-energy tradeoff given system state predictions. For instance, information as to a system state of the UE, such as its traffic pattern, energy cost, budget, or the like, may be input into the inference model to predict beneficial partial sensing parameters, which model may be optimized based on a loss or cost function (or its opposite such as a profit or reward function) representing a tradeoff between energy and reliability (or data rate) or other performance indicator of the model.

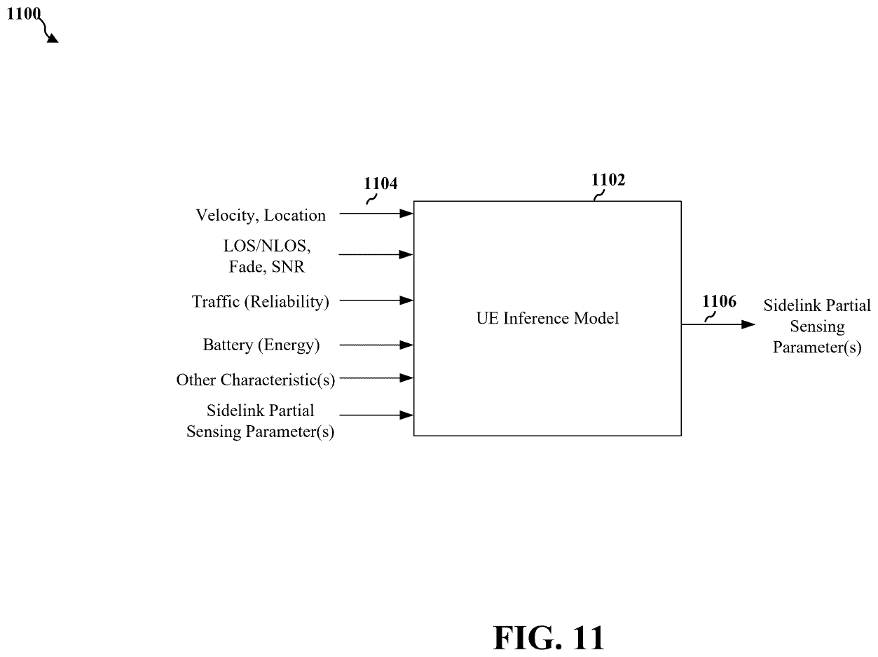

FIG. 11 illustrates an example 1100 of an inference model 1102 which receives system state information as inputs 1104 and which produces partial sensing parameters as outputs 1106 based on a profit function. The model may be a linear regression model, a reinforcement learning model, an online or expert learning system, long short term memory (LSTM), a convolutional neural network (CNN), a large language model (LLM), or other artificial intelligence or machine learning model including or not including a neural network. In one example, the system state information input to the model may include, but is not limited to, any combination of the UE's velocity, location, channel state, line of sight (LOS) or non-LOS indication, a fading parameter, a signal-to-noise (SNR) ratio, or a previous or predicted traffic pattern indicating a data arrival rate, a battery life, one or more KPIs such as a Joules-per-bit metric indicating a past or predicted energy consumption per bit, or other information. At least some of this information input into the inference model may be dynamic. For example, in the case of a UE which is a UAV, its speed and position, its battery life, a traffic pattern, channel characteristics of the wireless channel, or other model inputs may change over time. In another example, at least one or more of the system information may further or alternatively include partial sensing parameter(s) provided or configured by the network, such as any of the RRC parameters illustrated in FIG. 10.

The inference model 1102 may map system state information to one or more sidelink partial sensing parameters. For instance, the model may apply one or more activation functions or other functions to the system state information to output value(s) for one or more sidelink partial sensing parameters. The partial sensing parameters produced from the model may include, for example, value(s) for any of the RRC parameters illustrated in FIG. 10. For instance, when producing an allowed resource selection configuration parameter for partial sensing, the model may indicate which of the potential configurations the UE is to apply using one value such as ‘c3’ to indicate random selection, another value such as ‘c2’ to indicate partial sensing, a further value such as ‘c1’ to indicate full sensing, or the like. Alternatively, the model may provide the indication using different values or in a different manner, such as by outputting an integer index or a token or string indicating the parameter value. Similarly, the model may output a certain value M corresponding to a number of logical slots for contiguous partial sensing. The model may produce values for different partial sensing parameters over time in response to different, time-changing values for system state information inputs. The model may also be optimized over time, for example using gradient descent or other performance-based functions, to produce different partial sensing parameters to accommodate the dynamic changes of inputs. In the case where one or more of the inputs include partial sensing parameters provided by the network such as parameters 1004, these parameters may themselves be outputs of a same or similar inference model configured at the base station or other network entity. In such case, compared to the network's inference model, the inference model at the UE may output same or different values for the input partial sensing parameters. For instance, the UE's model may fine-tune the parameter(s) received from the base station which were output from the network entity's own model.

The inference model 1102 at the UE 104 may be trained or dynamically configured to minimize a cost function or maximize a profit function to result in partial sensing parameters which optimize a balance between energy and reliability. An example of a profit function may be, for example:

$$C = max ( {α}_{1} γ + \frac{{α}_{2}}{β} )$$

where γ is a function of reliability characteristics such as the sidelink data arrival rate, γ is a function of one or more energy characteristics such as the UE's battery life, and α₁ and α₂ are arbitrarily or otherwise configured scalar values. Using gradient descent or other performance-based function, the inference model 1102 may determine weights, biases or other factors to be associated with the different system state information inputs so that the profit function C may be maximized, or alternatively so that an associated loss or cost function in other examples may be minimized. For example, model weights, biases, or other model parameters may be updated so that the partial sensing parameter(s) output from the model represent a maximum sidelink data rate and a minimum energy consumption or effect on battery life. These weights, biases, or other model parameters may remain fixed following training, such as when the model is an LSTM, or may be dynamically changed following one or more inferences, such as when the model is part of an online learning system. In some cases, the inference model at the network entity may similarly be trained or dynamically configured to minimize or maximize a cost or profit function to result in optimized partial sensing parameters provided to the UE for input into its own model. In cases where the cost function or profit function of the network entity's model is not optimized, any outputs from the network entity that are input into the UE's model may be fine-tuned by the optimized UE model.

Generally, the network configures the UE with single values for individual RRC partial sensing parameters. For instance, referring to FIG. 10, the allowed resource selection configuration may indicate one of several enumerated values c1, c2, c3, c4, c5, c6, or c7 respectively indicating different resource selection combinations or singular selections such as random selection or PBPS. If the base station provides the value c1, for example, then the UE applies the resource selection associated with c. Similarly, a minimum number of candidate slots M for PBPS may indicate one value within the range of integers 0-31, which value the UE subsequently applies for its partial sensing.

In contrast, in one or more aspects of the present disclosure, the partial sensing parameters the network provides to the UE may indicate flexible thresholds, or optional values, that the UE may apply to perform its partial sensing based on its inference model 1102. For instance, if the base station 102 ascertains that the sidelink UE is a limited power UE such as a UAV or an IIoT device, the base station may flexibly indicate one or more optional values the UE 104 may selectively apply for a given parameter, rather than a mandatory single value the UE is to apply for a given partial sensing. For example, in the case of the allowed resource selection configuration parameter, the base station may provide the UE with a range of parameter options or values c1, c2, c3, c4, and c5, or some other flexible, consecutive or non-consecutive range of values, any one of which the UE may choose for its resource selection. The UE may then input the indicated range of values c1-c5 into its model to produce a single output c4 or other value for that same parameter, depending on whichever value results in the most energy-efficient partial sensing based on the UE's other inputs, model parameters, and the like at a given time. Similarly, if the base station provides a minimum number of candidate periodic slots M for PBPS, the base station may provide the UE with a range of parameter options or values such as 8, 16, and 30 (or other options which include or exclude one or more values), any one of which the UE may choose for its partial sensing. The UE may then input the indicated values 8, 16, and 30 into its model to produce a single output 16 or other value for that same parameter, depending on whichever value results in the most energy-efficient partial sensing based on the UE's other inputs, model parameters, and the like at a given time. In some examples, the range of options or values the UE may receive, or that the base station may provide, may exclude values which a limited power UE may not or cannot apply. For instance, if the UE or base station determines that resource allocations c6 and c7 for example, or a minimum number of candidate periodic slots 31 for example, are too power-intensive for an IIoT device or UAV, the UE or base station may exclude these values from its flexible thresholds provided to or utilized by the UE.

A sidelink UE may additionally or alternatively rely on an AI/ML model at the base station, core network, or other network entity to determine sidelink partial sensing parameters. For instance, the base station 102 may collect information such as data and measurements from the UE 104 as well as from or regarding other devices in the wireless communication system, including the UE's peers, peer group members, neighbors, and the like. The information may include first information or basic information, such as link measurements from peers of the UE, buffer status for sidelink connections, positioning or location information, and traffic information. The information may also include second information or advanced information. One example of advanced information includes the UE's proximity reports, such as UE proximity information based on local PC5 discovery and sensing and the like. This information may be used to determine potential peer UEs especially for groupcast and broadcast communication. Another example of advanced information is motion information, such as past and expected two dimensional or three-dimensional trajectory, past UE speed and acceleration, current UE speed and acceleration, and the like. This information may be used to determine which UEs may be current and future targets of communication, where in the network system the UE 104 is moving and the expected congestion that will be there, or the like. Another example of advanced information is environment information, or surrounding information to the UE such as structure detection information, scene information, blockage prediction information, or other information obtained from UE sensors such as its camera, RADAR, LIDAR, and the like. This information may be used to determine potential impact to link quality. For example, if the UE 104 is going to travel behind a building or a tree resulting in some blockage in communication, then aggressive partial sensing may be inefficient since the UE would likely miss the transmissions or resource reservations of other UEs. Another example of advanced information is device level information, such as an energy consumption report, a battery report, or a fault or failure report. This information may be used to determine how conservative or aggressive partial sensing may be applied. For example, if the network determines from a UE's device level information that it has had poor battery or other battery issues in the past, then the network may decide the UE would benefit from less partial sensing to save UE power.

Before or after performing sidelink communication, the UE 104 may collect basic information or advanced information including data and measurements and report this information to the base station 102. Using the basic information and the advanced information reported from the UE and possibly other UEs, the network entity may adjust the value of one or more sidelink partial sensing parameters to be applied by these UEs. For instance, the base station, core network, or other network entity may have an inference model identical or similar to the inference model of the UE which may receive the first information or second information as inputs and which may provide one or more partial sensing parameters as outputs to be used at a UE. In one example, the outputs from the model may be fixed parameters that the UE is to apply, such as c3 for the allowed resource configuration parameter shown in the RRC parameters of FIG. 10. In another example, the outputs from the model may be flexible thresholds, such as a range of values c1-c5 for the allowed resource configuration parameter, from which values the UE may select or possibly input into its own inference model to determine more fine-tuned partial sensing parameters at the UE. For instance, the UE may select to apply one value c3 within the flexible thresholds c1-c5 for its subsequent partial sensing and resource selection. The network entity may apply the inference model to output partial sensing parameters in cases, for example, where the UE does not have an inference model in its device, or where the network entity aggregates information from multiple UEs sent via a UAV swarm leader or the like, to determine flexible thresholds or other parameters for partial sidelink sensing for one or more UEs.

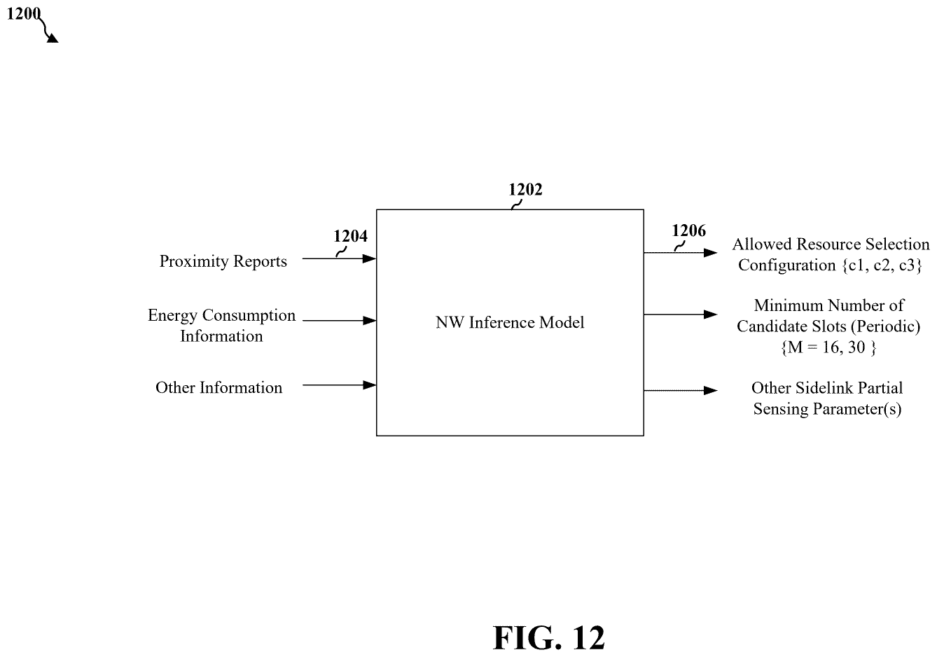

FIG. 12 illustrates an example 1200 of an inference model 1202 at a network entity such as base station 102 or core network 190. The inference model 1202 may, for example, have the same structure, characteristics, inputs, outputs, activation function, loss function, gain function, or other properties of the UE's inference model 1102 shown in FIG. 11. For instance, the inference model 1202 at the network entity may be a linear regression model, a reinforcement learning model, a model that is trained using supervised or unsupervised learning, or the model may include other characteristics or properties identical to or similar to the UE's inference model 1102 of FIG. 11. Using this model, the network entity may determine partial sensing parameters or a range of flexible thresholds for partial sensing such as previously described. For instance, the network entity's inference model may receive as inputs 1204 one or more of the first information or second information, apply activation or other functions to the inputs 1204 according to a same or similar configuration as that described with respect to the UE's inference model, and provide outputs 1206 of values for partial sensing parameters to be sent in an RRC configuration to the UE such as RRC parameters 1004 of FIG. 10. As an example, the network entity may receive proximity reports and energy consumption information from multiple UEs, input this information into its model, obtain as output from the model the values c1, c2, c3 for the UEs' allowed resource selection configurations and M=16 and 30 for their minimum number of candidate periodic slots, and provide these outputs as parameters 1004 to the UE(s).

The model may be trained, and afterwards applied, to output different values for partial sensing parameters based on determinations associated with the input information. For instance, as previously described, device level information may be used to determine how conservative or aggressive partial sensing may be applied. Thus, for example, more conservative partial sensing parameters may be output when the device level information indicates a weaker battery, while more aggressive partial sensing parameters may be output when the device level information indicates a stronger battery. Similarly, proximity UE reports, motion information, and environment information may indicate other information that the model may use to determine other factors for partial sensing as previously described. Changes in this advanced information may be used to adjust the model based on their underlying indications or associated determinations. As an example, the inference model may originally have one set of weights or biases applied to previous device level information input, that indicated UE 104 had less energy consumption and thus resulted in aggressive partial sensing parameters. However, later the base station 102 may receive further device level information from the UE that indicates a higher rate of energy consumption. In such case, the base station or model may adjust its set of weights or biases applied to device level information input to result in more conservative partial sensing parameters. The base station may then signal these parameters to the UE. Similar model adjustments and output changes may be made in connection with other information input to the model. Thus, after the UE sends the base station basic information and advanced information, the base station or other network entity or its model may determine a trend or other indication related to partial sensing based on the received information, and the base station or other network entity may send a set of partial sensing parameters output from the model at least in part based on this determination.

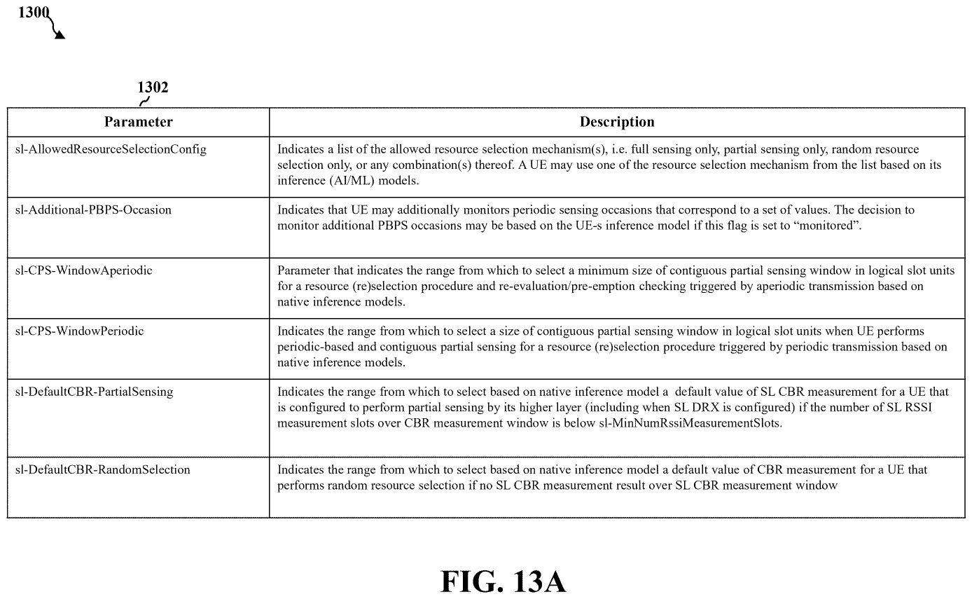

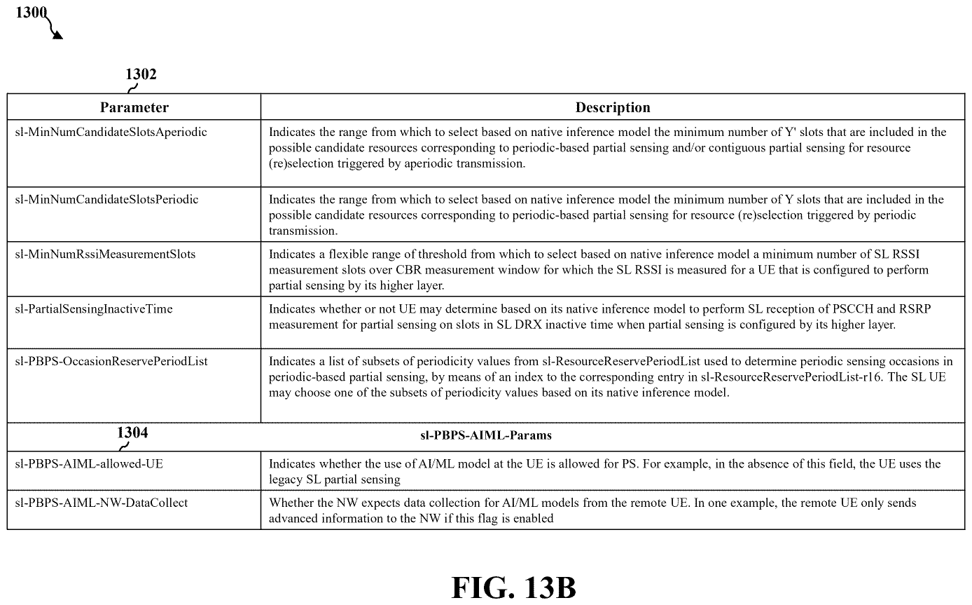

FIGS. 13A-13B illustrate an example 1300 of partial sensing parameters 1302 the network may configure or reconfigure for a sidelink UE. In this example, the parameters 1302 may be modified parameters of the IE 1002 illustrated in FIG. 10, although other parameters may be configured alternatively or additionally. Based on its inference model 1202, the base station 102 may indicate flexible thresholds for sidelink partial sensing. The base station may provide a list or arranged set or range of values for respective parameters from which the UE may select based on its own, native, inference model 1102. The thresholds or values are referred to as flexible since the UE may optionally determine whether to use these value(s), for example, based on whichever of them are output from its inference model 1102. In one example, the base station 102 may provide an allowed resource selection configuration parameter similar to that described with respect to FIG. 10, but here the parameter may indicate a list of the allowed resource selection mechanism(s) such as full sensing only, partial sensing only, random resource selection only, or any combination(s) thereof, rather than merely a single value. The UE may then use one of the resource selection mechanisms from the indicated list based on its inference (AI/ML) model(s). In another example, the base station may provide a CPS window size parameter for aperiodic transmissions similar to that described with respect to FIG. 10, but here the parameter may indicate the range from which to select a minimum size of contiguous partial sensing window in logical slot units for a resource (re)selection procedure and re-evaluation/pre-emption checking triggered by aperiodic transmission based on native inference models. In a further example, the base station may provide at least one of these parameters or any of the other parameters illustrated in FIGS. 13A-13B, which are similar to those described with respect to FIG. 10, but which provide more flexibility to the UE by indicating selection ranges or optionality as illustratively described.

Additionally, the base station 102 may provide additional parameters 1304 specific to inference models for partial sensing, or inference-based, partial sensing parameters. One or more of these parameters 1304 may indicate to the UE whether inference model-based partial sensing is allowed or whether advanced information reporting for network inference models is allowed. For instance, the base station 102 may provide an inference model allowed parameter (sl-PBPS-AIML-allowed-UE), which indicates whether the use of AI/ML model at the UE is allowed for partial sensing (PS). For example, in the absence of this field, the UE may apply legacy SL partial sensing without inference model 1102 such as described with respect to FIGS. 9A-9C. Thus, this parameter may indicate whether the UE may apply an inference model for partial sensing. Moreover, the base station 102 may provide a network data collection parameter (sl-PBPS-AIML-NW-DataCollect), which indicates whether the network (NW) expects data collection for AI/ML models such as for inference model 1202 from the sidelink or remote UE. In one example, the sidelink UE only sends advanced information to the NW if this flag is enabled. Thus, this parameter may indicate whether network data collection for an applied inference model is allowed.

In one aspect, a sidelink UE such as UE 104 may collect data from the network as well as its neighboring UEs. In one case, the sidelink UE may collect traces from UEs in its proximity or UEs which it may connect via PC5 discovery. These traces may include, for example, information about the UEs' current power savings schemes, the partial sensing parameter(s) used, and energy costs for current transmissions. These traces may also or alternatively include, for example, traffic information, and current or supported service information, such as traffic periodicities, traffic burst size, traffic arrival rates, and the like for a respective service or traffic type currently being served or which may be served in the future. These traces may also or alternatively include, for example, long term and medium term reliability, decodability, or latency metrics associated with one or more traffic types or services or with one or more groups of UEs. In another case, the sidelink UE may collect logs for channel measurements from the network or from the various sidelink UEs to which the UE is connected. The sidelink UE may be one which is in proximity to a particular UE or which supports services in which the UE is interested. In another aspect, the network may similarly collect data from sidelink UEs and other network nodes. For instance, the network may collect data on link measurements. In another example, the data which the network may collect is the advanced information illustrated and described with respect to FIG. 12, including, for example, proximity UE reports, motion information, environment information, and device level information. The base station may collect other data as well.

Based on the collected or reported data and the inference model 1102, 1202 at the UE or network, the UE 104 or base station 102 may utilize one or more values from a configuration list of partial sensing parameters for UE resource selection. For instance, the inference model 1102, 1202 of the UE or base station may output parameters to be applied or fine-tuned for partial sensing in mode 2 resource allocation. In this aspect, the inputs to the inference model may include not only the information or measurements that the UE or base station collected itself, but also include measurements and data collected from other UEs or other network nodes. For instance, if the UE collected data from multiple other UEs in the wireless communication system, the UE may include this collected information of the other UEs as further inputs to its inference model 1102 to determine partial sensing parameters. Similarly, the network may input collected information from the UE and the multiple other UEs into its inference model 1202 to similarly determine partial sensing parameters. Thus, by considering the performance or characteristics of other UEs in the system in this manner, the UE or network may determine, or output from their models, partial sensing parameters that are optimal for the overall system performance of the wireless communication system including the multiple UEs, rather than parameters which may be optimal solely for a single UE.

In one aspect, the network may collect or configure the UE to report performance KPIs to determine native inference model performance, such as whether the UE's inference model 1102 is operating efficiently. One example of a KPI is a UE energy metric, such as energy consumption per data unit (Joules per bit), energy consumption statistics over time, a configured energy score, or the like. Another example of a KPI is a communication efficiency metric, such as a data rate, latency, reliability, or other quality of service (QoS) metric associated with the UE or with respective services supported by the UE. A further example of a KPI is a failure log, which may include logs for data transmission failures, radio link failures, service level failures, or the like, which failure may have happened due to partial sensing. Based on the reported KPI(s) from the UE 104, the base station 102 may determine whether the UE's inference model 1102 is operating effectively or efficiently, whether the model should be retrained for more accurate results, whether a different model should be used or a change to another model should occur at the UE, or whether an inference model should not be used for a given duration of time. The network may collect other metrics than KPIs to make same or similar determinations.

In one example, the KPIs may not only be inputs to the UE or network's inference models 1102, 1202 for determination of partial sensing parameters, but the KPIs may also be considered in cost, loss, or gain functions to determine model performance. As an example, if given energy efficiency metrics, failure logs, or other KPIs input to the model are associated with certain weights and biases, but the model results in a cost or loss function that does not achieve a minimal result, or a gain function that does not achieve a maximum result, then the weights or biases associated with these KPIs may be modified in attempt to improve the model, or zeroed out to prevent the inputs' use in the model for example if the model is rendered inoperative for a duration of time. Thus, KPIs may be a basis for determining partial sensing parameters or a basis for determining or configuring inference model efficiency for outputting partial sensing parameters.

In one aspect, the network may provide adaptive flexible thresholds. For instance, the base station 102 may configure the UE 104 with multiple sets of flexible thresholds for a given partial sensing parameter. The UE may then apply these thresholds in combination with its local inference model for sidelink partial sensing. In one example, a respective set of flexible thresholds may be associated with a UE state. A UE state may be determined based on, or defined by, for example, a combination of any of the following: UE location, mobility, scene information, link state, or other local data collected by the UE. In another example, the network may determine multiple, or a quantity K, sets of flexible thresholds based on basic information obtained via UE data collection, KPI reports including over the air (OTA) reporting, or other information, and the base station may request the UE to perform partial sensing based on its local or native inference model using at least one of the configured sets of flexible thresholds. The sidelink UE may then, based on its local inference model, determine to use one or more of the multiple sets of configured flexible thresholds for partial sensing, for example, based on additional local link information, proximity information, current or predicted battery status, sensor information, and the like. While the UE is in the RRC connected state, the UE may notify the network of its current state of flexible parameters the UE is applying for sidelink partial sensing.

The data collection and inference model complexity may be split between the network and the sidelink UE. For instance, the determination of flexible thresholds for a given RRC parameter for partial sensing may be split between a smaller inference model at the network entity and a larger inference model at the UE. The network entity model, for example, may determine K sets of flexible thresholds for an individual parameter at least in part based on collected data or other information provided from UEs, while the UE model, for example, may determine which single set of these multiple sets of flexible thresholds to use for an individual parameter, as well as which flexible threshold in the determined single set to use for that same parameter, at least in part based on the collected data or other information. This split may occur especially in cases where the sidelink UE is a vehicle UE or otherwise has greater capability than IIoT devices or other limited capability UEs.

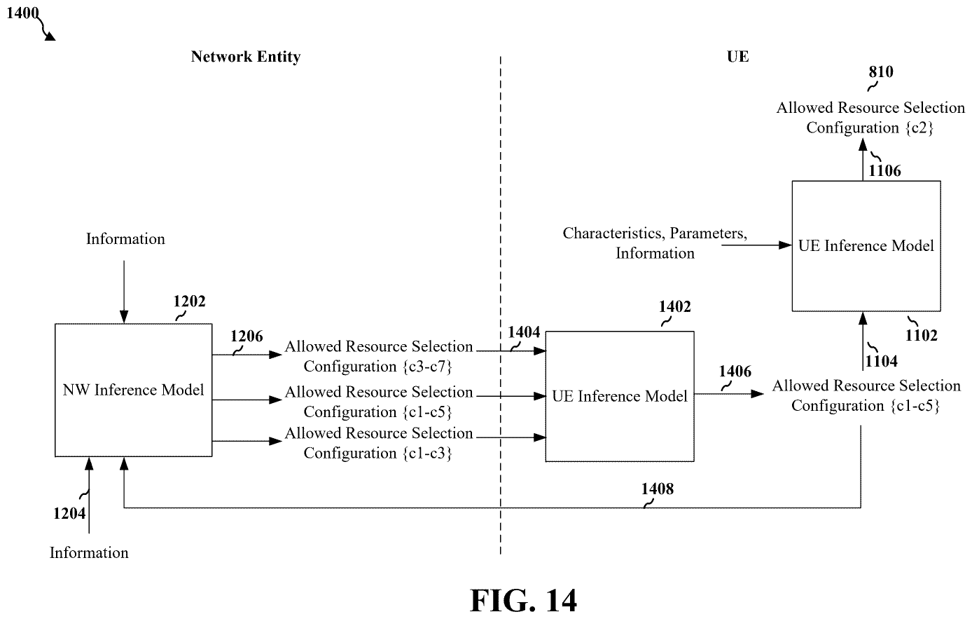

FIG. 14 illustrates an example 1400 of a split, data collection and inference model architecture between a network entity and a UE. In one example, for the allowed resource selection parameter, one set of flexible thresholds or values c3-c7 may be associated with one UE state defined by one UE location or other local data, another set of flexible thresholds or values c1-c5 may be associated with another UE state defined by another location or other local data, while a further set of flexible thresholds or values c1-c3 may be associated with another UE state defined by a further location or other local data. The network entity may utilize its native, inference model 1202 to determine or output these sets of flexible thresholds as potential values from which the UE may select to apply for partial sensing, for example based on UE information or other inputs 1204 such as described with respect to FIG. 12. The network entity may then signal these sets and possibly other sets to the UE as parameters 1004.

After the network entity transmits and the UE receives these parameters 1004, the UE may then provide the sets of values associated with the given parameters as inputs 1404 into a native, inference model 1402, which may be similar to inference model 1102 but configured with different weights and biases, with a different model, or with other model factors. The UE may provide these inputs 1404 to its inference model 1402 along with possibly other model inputs, such as the system state information described with respect to FIG. 11 or the basic or advanced information described with respect to FIG. 12. This inference model 1402 may then determine which set of values for a given parameter is to be the set from which the UE may flexibly select for partial sensing. For instance, the inference model 1402 may determine which set to use for the allowed resource selection parameter out of sets c3-c7, c1-c5, and c1-c3. For example, the UE model may input c3-c7 as a first configuration, c1-c5 as a second configuration, and c1-c3 as a third configuration, and the UE model may produce as output 1406 the second configuration or set c1-c5 as the set of flexible thresholds to be used for this parameter.

Then, a second UE model such as inference model 1102 may select which of the adaptive flexible thresholds to apply that was previously output from inference model 1402. For example, inference model 1102 may receive this second configuration or set c1-c5 as one of its inputs 1104, along with other model inputs such as the system state information shown in FIG. 11. The second UE model may then determine or produce as output 1106 whichever value from the set the UE is to use as the allowed resource selection parameter for partial sensing, such as c3 in the illustrated example.

Moreover, in addition to applying the output of the inference model 1102 for partial sensing, such as c3 in this example, the UE may transmit a report 1408 of the output of the inference model 1402 to the base station for future reference, such as c1-c5 in this example. The base station may then adapt its subsequent flexible thresholds in response to this report 1408. For instance, in response to receiving this information from the UE, the base station may determine that the UE decided to use the second configuration c1-c5 that the base station previously sent to the UE in its multiple sets of flexible thresholds. The base station may similarly receive information from other UEs, including which set of flexible thresholds these other UEs determined to apply using their own native inference models. The base station may then utilize or refer to this information when sending subsequent sets of flexible thresholds to UEs.

Thus, rather than providing the UE with one set of flexible thresholds for a given RRC parameter for partial sensing as previously described, in this aspect the base station may provide multiple sets of flexible thresholds for a given parameter which the UE may apply. For instance, the base station, core network, or other network entity may output K sets of flexible thresholds from its native inference model for a given partial sensing parameter, provide these K sets of flexible thresholds to the UE, and the UE may then input these K sets of flexible thresholds into its native inference model and output one of these K sets of flexible thresholds for that partial sensing parameter. The UE may then in its same model or a different inference model input the determined one of these K sets of flexible thresholds to produce one flexible threshold out of the determined set the UE may apply for its partial sensing, or otherwise determine which flexible threshold to use for partial sensing based on the determined one of these K sets of flexible thresholds. Unlike prior examples where the network determines using its own model which one of the K sets of flexible thresholds the UE is to apply, here the network offloads that determination to the UE's model. This complexity or split architecture may apply in cases where the UE can support multiple inference models, such as in cases where the UE is a vehicle UE.

In another aspect, the sidelink UE may request the network to add, modify, or remove one or more sets of flexible thresholds, such as one or more of the K sets of flexible thresholds previously described, based on its performance or the local inference model at the UE or network. In one example, the request may be associated with a change in UE state, such as a change in its mobility, trajectory, scene, or the like. For instance, a vehicle UE may experience a scene change and thus a change in UE state if it exits from a freeway into a city. In another example, the request may be associated with performance KPIs corresponding to the use of one or more sets of flexible thresholds for sidelink partial sensing. In a further example, the UE may indicate to the network one or more sets or lists of flexible thresholds based on its own local inference model, which indication the network may consider as a request to fine tune its model or sets of flexible thresholds to be subsequently indicated to the UE.

As an illustration of this aspect, referring again to FIG. 14, the UE 104 may receive three sets of flexible thresholds for the allowed resource selection parameter c3-c7, c1-c5, and c1-c3 as previously described, but the UE may here determine based on its inference model 1402 that the set of thresholds c3-c7 is no longer optimal or relevant to its situation, a new UE state, or the like. For instance, based on performance KPIs, which may or may not be input into its inference model 1402, the UE may determine that the set c3-c7 results in the least minimized loss or cost function, or the least maximized gain function, in comparison to the sets c1-c5 and c1-c3. This result may occur, for example, in cases where the UE has changed its UE state, such as following an exit from a freeway to a city, resulting in different collected data metrics or advanced information being input into the UE's model that render the set c3-c7 suboptimal. Alternatively, or additionally, this result may occur, for example, in cases where the UE determines the set of thresholds to be prohibitive for partial sensing for that UE, possibly based on UE energy metrics or other performance KPIs input into the model. For example, the UE may be a UAV that does not have the battery power to support at least certain ones of these thresholds or values in the set.

In such case(s), the UE may provide a request, for example via report 1408, indicating the base station to no longer send the set c3-c7 to the UE in its subsequent sets of flexible thresholds. Thus, the base station may remove the set c3-c7 from being indicated in subsequent sets of flexible thresholds in response to the UE's request. The request may thus be associated with UE state, associated with sidelink partial sensing performance KPIs, based on its local model, or based on or associated with a combination of the foregoing. Alternatively, or additionally, the UE may determine a different set of flexible thresholds for the sidelink partial sensing parameter to be more optimal or relevant based on any combination of the foregoing factors. For instance, the UE's inference model 1402 may output the subset c2-c4 as the most optimal range within the input ranges for the allowed resource selection configuration parameter. In such case, the UE may request the network via report 1408 or a different message to add this different set of flexible thresholds such as c2-c4 to its list of parameter values or thresholds, or to modify one of the sets in its list of parameter values or thresholds, accordingly for at least this UE. For instance, in a subsequent transmission, the base station may provide the set c2-c4 as an alternative or additional output 1206 to the UE 104 for the allowed resource selection configuration parameter.

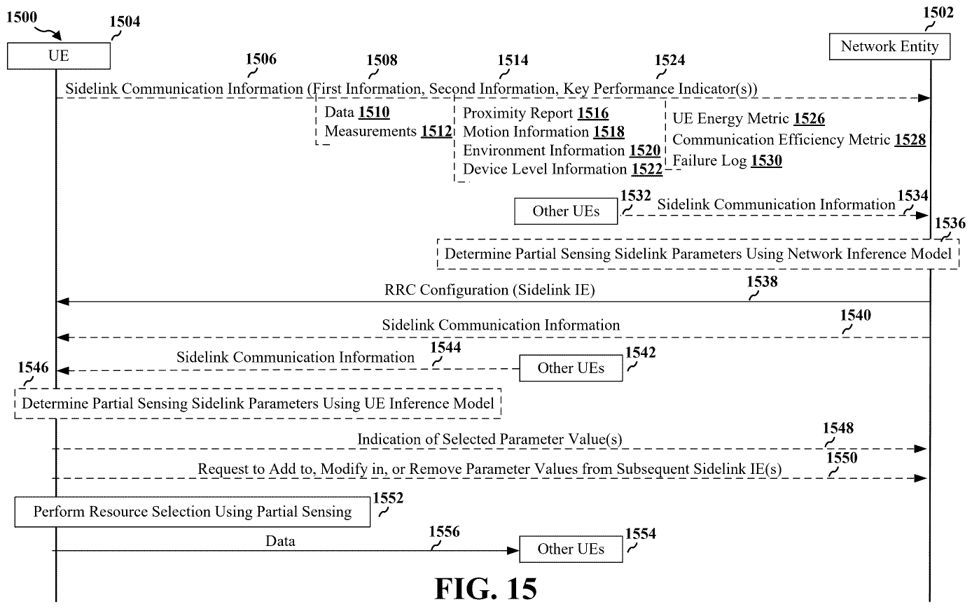

FIG. 15 illustrates an example 1500 of a call flow between a network entity 1502 and a UE 1504. UE 1504 may correspond to UE 104, 650. The network entity 1502 may correspond to base station 102/180, 610, disaggregated base station 181, a component of disaggregated base station 181 such as CU 183, DU 185, or RU 187, UE 104, or other network entity. In this example 1500, a communication process between the network entity 1502 and UE 1504 is depicted illustrating various aspects of the present disclosure, which in general provide for optimized sidelink power savings in connection with partial sensing. Optional aspects are illustrated in dashed lines.

The UE may transmit, and the network entity may receive, sidelink communication information 1506. The sidelink communication information 1506 may include any of basic or first information 1508, such as data 1510 or measurements 1512; advanced or second information 1514, such as a proximity report 1516, motion information 1518, environment information 1520, or device level information 1522; or KPI(s) 1524, such as a UE energy metric 1526, communication efficiency metric 1528, or failure log 1530. Alternatively or additionally, other UEs 1532 may transmit, and the network entity 1502 may receive, similar sidelink communication information 1534. For instance, the network entity 1502 may collect basic information and advanced information from the UE 104 as well as from or regarding other devices in the wireless communication system, including the UE's peers, peer group members, neighbors, and the like.

At block 1536, the network entity 1502 may determine partial sensing sidelink parameters using a network inference model. For instance, the UE 1504 may rely on inference model 1202 at the network entity 1502 to determine sidelink partial sensing parameters, such as described with respect to FIG. 12. For example, the network entity 1502 may have network inference model 1202 identical or similar to the inference model 1102 of the UE which may receive the first information 1508 or second information 1514 as inputs and which may provide one or more partial sensing parameters 1302 as outputs to be used at the UE 1504. In various aspects, the partial sensing parameters 1302 produced from the inference model 1202 may be flexible thresholds, such as illustrated and described with respect to FIGS. 13A-13B, or adaptive flexible thresholds, such as described with respect to FIG. 14.

Afterwards, the network entity 1502 may transmit, and the UE 1504 may receive, an RRC configuration 1538 including a sidelink IE. For instance, the RRC configuration 1538 may include the PBS and CPS configuration IE 1002 illustrated in FIG. 10. The sidelink IE 1002 may include the determined, partial sensing sidelink parameters 1302 at block 1536. For instance, the parameters 1302 may be modified parameters of the IE 1002 such as illustrated and described in FIGS. 13A-13B, although other parameters may be configured alternatively or additionally such as additional parameters 1304. In some aspects, the partial sensing parameters 1302 the network entity 1502 provides to the UE 1504 may indicate flexible thresholds, or optional values, that the UE may apply to perform its partial sensing. In some aspects, the flexible thresholds may be adaptive, such as described with respect to FIG. 14. For instance, the network entity 1502 may configure the UE 1504 with multiple sets of flexible thresholds, respectively associated with a UE state, for a given partial sensing parameter.

The network entity 1502 may also transmit, and the UE 1504 may also receive, sidelink communication information 1540. The sidelink communication information 1540 may be similar to sidelink communication information 1506 received from the UE. Alternatively or additionally, other UEs 1542 may transmit, and the UE 1504 may receive, similar sidelink communication information 1544. For instance, UE 1504 may collect data from the network as well as its neighboring UEs. In one example, UE 1504 may collect traces from UEs in its proximity or UEs which it may connect via PC5 discovery. In another example, UE 1504 may collect logs for channel measurements from the network or from the various sidelink UEs to which the UE is connected.

At block 1546, the UE 1504 may determine partial sensing sidelink parameters using a UE inference model. For instance, the UE 1504 may rely on UE inference model 1102 to determine parameters for partial sensing, such as described with respect to FIG. 11. For example, sidelink communication information 1540 or 1544 such as UE characteristics or system state information or parameters 1004 including flexible thresholds may be input into the inference model 1102 of the UE to output partial sensing parameters such as one or more values for any of the RRC partial sensing parameters of FIG. 10. In some aspects, if adaptive flexible thresholds are provided, or data collection and inference model complexity is split between the network and the UE, the UE 1504 may determine to use one or more of multiple sets of configured flexible thresholds for partial sensing using inference model 1402, such as described with respect to FIG. 14. The UE 1504 may then select using inference model 1102 which of the adaptive flexible thresholds previously output from inference model 1402 to apply.

Optionally, the UE 1504 may transmit, and the network entity 1502 may receive, an indication 1548 of selected parameter value(s). For instance, while the UE is in the RRC connected state, the UE 1504 may notify the network entity 1502 of its current state of flexible parameters the UE is applying for sidelink partial sensing. For example, the UE 1504 may transmit report 1408 of the output of the inference model 1402 to the network entity 1502 for the network entity to adapt its subsequent flexible thresholds. Additionally or alternatively, the UE 1504 may transmit, and the network entity 1502 may receive, a request 1550 to add to, modify in, or remove selected parameter value(s) from subsequent sidelink IEs. For instance, the UE 1504 may request via report 1408 the network entity 1502 to add, modify, or remove one or more sets of flexible thresholds based on its performance or based on the inference model 1102, 1202, 1402 at the UE or network entity.

At block 1552, the UE 1504 may perform resource selection using partial sensing. For instance, the UE 1504 may apply a resource sensing and selection procedure in connection with mode 2 resource allocation in resource pool 800, such as illustrated and described with respect to FIG. 8, using partial sensing, such as illustrated and described with respect to any of the examples 900, 920, 940 of FIGS. 9A-9C. Afterwards, the UE 1504 may transmit, and other UEs 1554 may receive, sidelink data 1556 in the selected resources, such as control information in PSCCH or data in PSSCH.

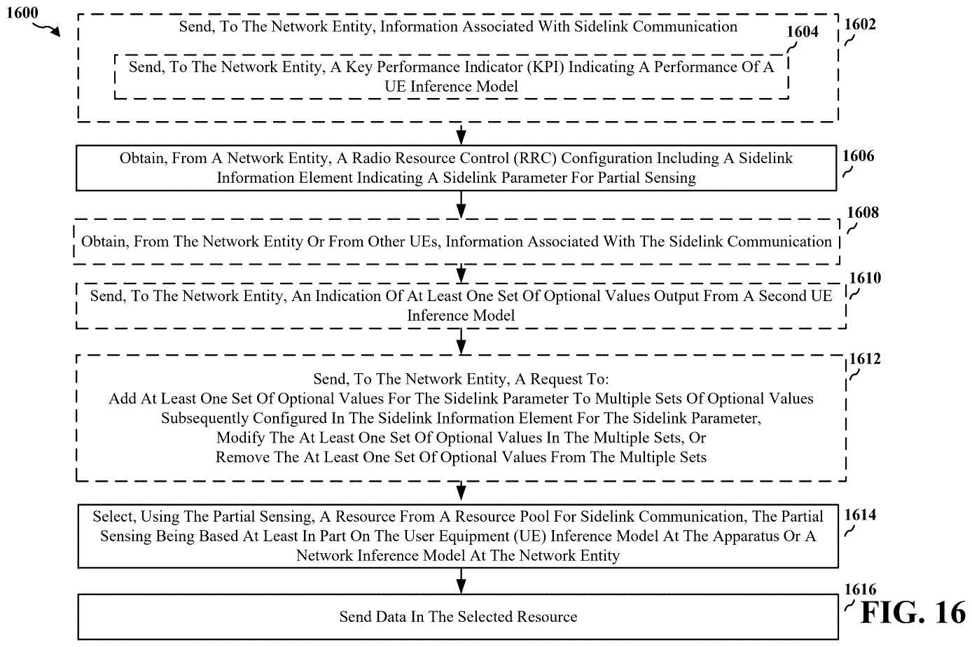

FIG. 16 is a flowchart 1600 of a method of wireless communication. The method may be performed by a UE or one or more of its components, for example, the UE 104, 650, 1504; one or more of RX processor(s) 656, TX processor(s) 668, or controller(s)/processor(s) 659; the apparatus 1802; or cellular baseband processor(s) 1804 or its components. Optional aspects are illustrated in dashed lines.

At block 1602, the UE may send, to a network entity, information associated with a sidelink communication. For example, block 1602 may be performed by information component 1840. As an example, at block 1604, the UE may send, to the network entity, a KPI indicating a performance of a UE inference model. For instance, referring to the Figures, the UE 1504 may transmit sidelink communication information 1506 to network entity 1502. In one example, the sidelink communication information 1506 may include one or more KPIs 1524 indicating performance of UE inference model 1102, 1402.

At block 1606, the UE may obtain, from a network entity, a RRC configuration including a sidelink information element indicating a sidelink parameter for partial sensing. For example, block 1602 may be performed by configuration component 1842. Obtaining may include, for example, receiving, demodulating, and decoding an encoded and modulated signal including the RRC configuration using one or more of RX processor(s) 656 or controller(s)/processor(s) 659 such as described with respect to UE 650 in FIG. 6. For instance, referring to the Figures, the UE 1504 may receive RRC configuration 1538 including IE 1002 from network entity 1502. IE 1002 may indicate parameters 1004 for partial sensing, such as random selection, CPS, or PBPS parameters.

At block 1608, the UE may obtain, from the network entity or from other UEs, information associated with the sidelink communication. For example, block 1608 may be performed by information component 1840. For instance, referring to the Figures, the UE 1504 may receive sidelink communication information 1540, 1544 from the network entity 1502 or other UEs 1542.

At block 1610, the UE may send, to the network entity, an indication of at least one set of optional values output from a second UE inference model. For instance, referring to the Figures, the UE 1504 may transmit indication 1548 of selected parameter value(s) produced from UE inference model 1402 to network entity 1502.

At block 1612, the UE may send, to the network entity, a request to: add at least one set of optional values for the sidelink parameter to multiple sets of optional values subsequently configured in the sidelink information element for the sidelink parameter, modify the at least one set of optional values in the multiple sets, or remove the at least one set of optional values from the multiple sets. For instance, referring to the Figures, the UE 1504 may transmit request 1550 to add to, modify in, or remove parameter values from subsequent sidelink IEs to network entity 1502.

At block 1614, the UE may select, using the partial sensing, a resource from a resource pool for sidelink communication, the partial sensing being based at least in part on a UE inference model at the UE or a network inference model at the network entity. For example, block 1614 may be performed by selection component 1844. For instance, referring to the Figures, at block 1552, the UE 1504 may select resources 810 in resource pool 800 using partial sensing, such as described with respect to FIG. 8 and any of 9A-9C. The partial sensing may be based at least in part on UE inference model 1102, 1402, network inference model 1202, or any combination of the foregoing. For instance, when the UE applies partial sensing to reduce power consumption by reducing channel sensing operations, an inference model at the UE or network's model inference host 304 such as ANN 200 or ML model 730 may be applied to optimize or enhance the partial sensing operation. For example, the network entity or base station 102 as agent 308 may determine via its inference model a set of parameters that may reduce power consumption of UAV swarms, while individual UEs as agents 308 may fine tune these parameters via their respective inference model(s) to trade off communication and device energy efficiency, including device energy consumption metrics and the like. In one example, referring to the RRC parameters of FIG. 10, the UE 104 may originally be indicated to apply full, continuous sensing based on the sidelink allowed resource selection configuration parameter (sl-AllowedResourceSelectionConfig), and its inference model may then indicate the UE 104 to switch from full sensing to partial sensing, including random selection, CPS, or PBPS.

Finally, at block 1616, the UE may send data in the selected resource. For example, block 1616 may be performed by information component 1840. Sending may include, for example, encoding, modulating, and transmitting the data using one or more of TX processor(s) 668 or controller(s)/processor(s) 659 such as described with respect to UE 650 in FIG. 6. For instance, referring to the Figures, the UE 1504 may transmit data 1556 to other UEs 1554 in the selected resource at block 1552.

In one example, at least one value for the sidelink parameter is an input to the UE inference model. For instance, referring to the Figures, parameters 1004 may be input into the inference model 1102 of the UE to produce partial sensing parameters 1302. Examples of parameters 1004 input to the UE's model 1102 may include, for example, the RRC partial sensing parameters of FIG. 10.

In one example, at least one KPI associated with the sidelink communication, or UE system information, is an input to the UE inference model. For instance, referring to the Figures, UE characteristics may be input into the inference model 1102 of the UE to produce partial sensing parameters 1302. Examples of UE characteristics input to the UE's model 1102 may include one or more KPIs 1524, such as, for example, how the UE's battery is behaving, what is the UE's traffic pattern, or the like. Information as to a system state of the UE, such as its traffic pattern, energy cost, budget, or the like, may be input into the inference model 1102 to predict beneficial partial sensing parameters. In one example, the system state information input to the model may include, but is not limited to, any combination of the UE's velocity, location, channel state, LOS or non-LOS indication, a fading parameter, a SNR ratio, or a previous or predicted traffic pattern indicating a data arrival rate, a battery life, one or more KPIs 1524 such as a Joules-per-bit metric indicating a past or predicted energy consumption per bit, or other information. At least some of this information input into the inference model may be dynamic.

In one example, at least one selected value for the sidelink parameter is an output of the UE inference model, the partial sensing using the at least one selected value. For instance, referring to the Figures, the model 1102 may apply one or more activation functions or other functions to the system state information to output value(s) for one or more sidelink partial sensing parameters 1302. The partial sensing parameters 1302 produced from the model 1102 may include, for example, value(s) for any of the RRC parameters 1004 illustrated in FIG. 10. For instance, when producing an allowed resource selection configuration parameter for partial sensing, the model may indicate which of the potential configurations the UE is to apply using one value such as ‘c3’ to indicate random selection, another value such as ‘c2’ to indicate partial sensing, or the like. Similarly, the model may output a certain value M corresponding to a number of logical slots for contiguous partial sensing.

In one example, the sidelink information element configures a plurality of optional values for the sidelink parameter, the optional values are an input to the UE inference model, and at least one selected value for the sidelink parameter from the optional values is an output of the UE inference model, the partial sensing using the at least one selected value. For instance, referring to the Figures, the base station may flexibly indicate one or more optional values the UE 104 may selectively apply for a given parameter, rather than a mandatory single value the UE is to apply for a given partial sensing. For example, in the case of the allowed resource selection configuration parameter, the base station may provide the UE with a range of parameter options or values c1, c2, c3, c4, and c5, or some other flexible, consecutive or non-consecutive range of values, any one of which the UE may choose for its resource selection. The UE may then input the indicated range of values c1-c5 into its model to produce a single output c4 or other value for that same parameter, depending on whichever value results in the most energy-efficient partial sensing based on the UE's other inputs, model parameters, and the like at a given time. Similarly, if the base station provides a minimum number of candidate periodic slots M for PBPS, the base station may provide the UE with a range of parameter options or values such as 8, 16, and 30 (or other options which include or exclude one or more values), any one of which the UE may choose for its partial sensing. The UE may then input the indicated values 8, 16, and 30 into its model to produce a single output 16 or other value for that same parameter, depending on whichever value results in the most energy-efficient partial sensing based on the UE's other inputs, model parameters, and the like at a given time.

In one example, at least part of the information sent at block 1602 is an input to the network inference model, and at least one value for the sidelink parameter is an output of the network inference model. For instance, referring to the Figures, the network entity's inference model 1202 may receive as inputs 1204 one or more of the first information 1508 or second information 1514 in sidelink communication information 1506, apply activation or other functions to the inputs 1204 according to a same or similar configuration as that described with respect to the UE's inference model 1102, and provide outputs 1206 of values for partial sensing parameters 1302 to be sent in RRC configuration 1538 to the UE such as RRC parameters 1004 of FIG. 10.

In one example, the information sent at block 1602 includes: first information including data or measurements of at least one of the UE or other UEs in communication with the UE, and second information including at least one of: a proximity report of the UE, motion information of the UE, environment information of the UE, or device level information of the UE, the second information being the at least the part of the information input to the network inference model. For instance, referring to the Figures, the sidelink communication information 1506 may include first information 1508 or basic information, such as link measurements from peers of the UE, buffer status for sidelink connections, positioning or location information, and traffic information. The sidelink communication information 1506 may also include second information 1514 or advanced information. One example of advanced information includes the UE's proximity reports 1516, such as UE proximity information based on local PC5 discovery and sensing and the like. Another example of advanced information is motion information 1518, such as past and expected two dimensional or three-dimensional trajectory, past UE speed and acceleration, current UE speed and acceleration, and the like. Another example of advanced information is environment information 1520, or surrounding information to the UE such as structure detection information, scene information, blockage prediction information, or other information obtained from UE sensors such as its camera, RADAR, LIDAR, and the like. Another example of advanced information is device level information 1522, such as an energy consumption report, a battery report, or a fault or failure report.

In one example, the sidelink information element configures a plurality of optional values for the sidelink parameter, and the optional values are an output of the network inference model, the partial sensing using at least one selected value from the optional values. For instance, referring to the Figures, the outputs from the network inference model 1202 transmitted in IE 1002 may be flexible thresholds, such as a range of values c1-c5 for the allowed resource configuration parameter, from which values the UE may select or possibly input into its own inference model 1102 to determine more fine-tuned partial sensing parameters at the UE. For instance, the UE may select to apply one value c3 within the flexible thresholds c1-c5 for its subsequent partial sensing and resource selection.

In one example, the sidelink information element is a PBPS and CPS configuration information element that configures a plurality of optional values for the sidelink parameter, the optional values are an output of the network inference model, and at least one selected value for the partial sensing from the optional values is an output of the UE inference model. For instance, referring to the Figures, the IE 1002 may include parameters 1302 such as illustrated and described with respect to FIGS. 13A-13B, which are modified parameters of the PBPS and CPS configuration IE illustrated in FIG. 10, although other parameters may be configured alternatively or additionally. Based on its inference model 1202, the base station 102 may indicate flexible thresholds in these parameters 1302 for sidelink partial sensing. For instance, the base station may provide a list or arranged set or range of values for respective parameters 1302 from which the UE may select based on its own, native, inference model 1102.

In one example, the sidelink information element further includes a partial sensing parameter indicating whether the partial sensing based at least in part on the UE inference model is allowed. For instance, referring to the Figures, the base station 102 may provide in the IE 1002 an inference model allowed parameter (sl-PBPS-AIML-allowed-UE) such as illustrated in FIG. 13B, which indicates whether the use of inference model 1102, 1402 at the UE is allowed for partial sensing.

In one example, the sidelink information element further includes a partial sensing parameter indicating whether information sent to the network entity in association with the sidelink communication is to be input to the network inference model for partial sensing. For instance, referring to the Figures, the base station 102 may provide in the IE 1002 a network data collection parameter (sl-PBPS-AIML-NW-DataCollect) such as illustrated in FIG. 13B, which indicates whether the network expects sidelink communication information 1506, 1534 or other data collection for its inference model 1202.

In one example, the sidelink information element configures a plurality of optional values for the sidelink parameter, the information obtained at block 1608 is an input to the UE inference model, and at least one selected value for the sidelink parameter from the optional values is an output of the UE inference model, the partial sensing using the at least one selected value. For instance, referring to the Figures, based on the collected, sidelink communication information 1540 and the inference model 1102 at the UE, the UE 104 may utilize one or more values from a configuration list of partial sensing parameters for UE resource selection. For instance, the inference model 1102, 1402 of the UE may output parameters to be applied or fine-tuned for partial sensing in mode 2 resource allocation. In this aspect, the inputs to the inference model may include not only the information or measurements that the UE collected itself, but also include measurements and data collected from other UEs or other network nodes. For instance, if the UE collected data from multiple other UEs in the wireless communication system, the UE may include this collected information of the other UEs as further inputs to its inference model 1102, 1402 to determine partial sensing parameters.

In one example, the information obtained at block 1608 includes at least one of: traces or channel measurement logs associated with the other UEs. For instance, referring to the Figures, in one case, the sidelink UE may collect in sidelink communication information 1540, 1544 traces from UEs in its proximity or UEs which it may connect via PC5 discovery. These traces may include, for example, information about the UEs' current power savings schemes, the partial sensing parameter(s) used, and energy costs for current transmissions. These traces may also or alternatively include, for example, traffic information, and current or supported service information, such as traffic periodicities, traffic burst size, traffic arrival rates, and the like for a respective service or traffic type currently being served or which may be served in the future. These traces may also or alternatively include, for example, long term and medium term reliability, decodability, or latency metrics associated with one or more traffic types or services or with one or more groups of UEs. In another case, the sidelink UE may collect in sidelink communication information 1540, 1544 logs for channel measurements from the network entity 1502 or from the various sidelink UEs to which the UE is connected. The other UEs 1532, 1542, 1554 may be those which are in proximity to a particular UE or which supports services in which the UE is interested.

In one example, information associated with the sidelink communication from other UEs than the UE is an input to the network inference model, and at least one value for the sidelink parameter is an output of the network inference model, the partial sensing using the at least one value. In another example, this information includes at least one of: link measurement data of the other UEs, proximity reports of the other UEs, motion information of the other UEs, environment information of the other UEs, or device level information of the other UEs. For instance, referring to the Figures, the network may collect in sidelink communication information 1506, 1534 data on link measurements. In another example, the sidelink communication information 1506, 1534 which the network entity 1502 may collect is the second information 1514 illustrated and described with respect to FIG. 12, including, for example, proximity UE reports 1516, motion information 1518, environment information 1520, or device level information 1522. Based on this information 1506, 1534 and the inference model 1202 at the network, the network entity 1502 may utilize one or more values from a configuration list of partial sensing parameters for UE resource selection. For instance, the inference model 1202 of the base station may output parameters to be applied or fine-tuned for partial sensing in mode 2 resource allocation. In this aspect, the inputs to the inference model may include not only the information or measurements that the base station collected itself, but also include measurements and data collected from other UEs or other network nodes. For instance, the network entity 1502 may input collected information from the UE and the multiple other UEs into its inference model 1202 to similarly determine partial sensing parameters.

In one example, the KPI sent at block 1604 is a UE energy metric, a communication efficiency metric of the UE, or a failure log of the UE. For instance, referring to the Figures, one example of KPI 1524 is a UE energy metric, such as energy consumption per data unit (Joules per bit), energy consumption statistics over time, a configured energy score, or the like. Another example of KPI 1524 is a communication efficiency metric, such as a data rate, latency, reliability, or other QoS metric associated with the UE or with respective services supported by the UE. A further example of KPI 1524 is a failure log, which may include logs for data transmission failures, radio link failures, service level failures, or the like, which failure may have happened due to partial sensing.

In one example, the sidelink information element configures multiple sets of optional values for the sidelink parameter, the multiple sets are an input to a second UE inference model, at least one set of optional values selected from the multiple sets is an output of the second UE inference model, the at least one set of optional values is an input to the UE inference model, and at least one selected value for the sidelink parameter from the at least one set is an output of the UE inference model, the partial sensing using the at least one selected value. For instance, referring to the Figures, the determination of flexible thresholds for a given RRC parameter 1004 in IE 1002 for partial sensing may be split between a smaller, inference model 1202 at the network entity 1502 and multiple inference models 1102, 1402 at the UE 1504. Foor example, with reference to FIG. 14, the network entity model 1202 may determine multiple sets of flexible thresholds for an individual parameter at least in part based on information 1506, 1534 provided from UEs, the UE inference model 1402 may determine which single set of these multiple sets of flexible thresholds to use for an individual parameter, and the UE inference model 1102 may determine which flexible threshold in the determined single set to use for that same parameter, at least in part based on the information 1540, 1544.

In one example, the multiple sets of optional values are respectively associated with a UE state, the multiple sets of optional values are an output from the network inference model based on reported information associated with the sidelink communication, the reported information being an input to the network inference model and including at least one of: UE data or key performance indicators (KPIs), and the at least one set of optional values output from the second UE inference model is based on additional information associated with the sidelink communication input to the second UE inference model. For instance, referring to the Figures including the allowed resource selection parameter referenced in FIG. 14, one set of flexible thresholds or values c3-c7 may be associated with one UE state defined by a combination of any of the following: UE location, mobility, scene information, link state, or other local data collected by the UE, another set of flexible thresholds or values c1-c5 may be associated with another UE state defined by another combination of any of the foregoing, while a further set of flexible thresholds or values c1-c3 may be associated with another UE state defined by a further combination of any of the foregoing. The network entity may utilize its native, inference model 1202 to determine or output these sets of flexible thresholds as potential values from which the UE may select to apply for partial sensing, for example based on information 1506, 1534 input into the model 1202. The network entity may then signal these sets and possibly other sets to the UE as parameters 1004. After the network entity transmits and the UE receives these parameters 1004, the UE may then provide the sets of values associated with the given parameters as inputs 1404 into its native, inference model 1402, along with possibly other inputs, such as the system state information described with respect to FIG. 11, the basic or advanced information described with respect to FIG. 12, or information 1540, 1544. This inference model 1402 may then determine which set of values for a given parameter is to be the set from which the UE may flexibly select for partial sensing.

In one example, the request sent at block 1612 is based on at least one of: a change in UE state, a KPI associated with the at least one set of optional values, or an output from the UE inference model based on the at least one set of optional values. For instance, referring to the Figures, when the UE 1504 sends request 1550 to the network entity 1502 to add, modify, or remove one or more sets of flexible thresholds, in one example, the request may be associated with a change in UE state, such as a change in its mobility, trajectory, scene, or the like. For instance, a vehicle UE may experience a scene change and thus a change in UE state if it exits from a freeway into a city. In another example, the request may be associated with performance KPIs corresponding to the use of one or more sets of flexible thresholds for sidelink partial sensing, such as KPI 1524. In a further example, the UE may indicate to the network one or more sets or lists of flexible thresholds based on its own local inference model 1102, 1402, which indication 1548 the network may consider as a request to fine tune its model or sets of flexible thresholds to be subsequently indicated to the UE.

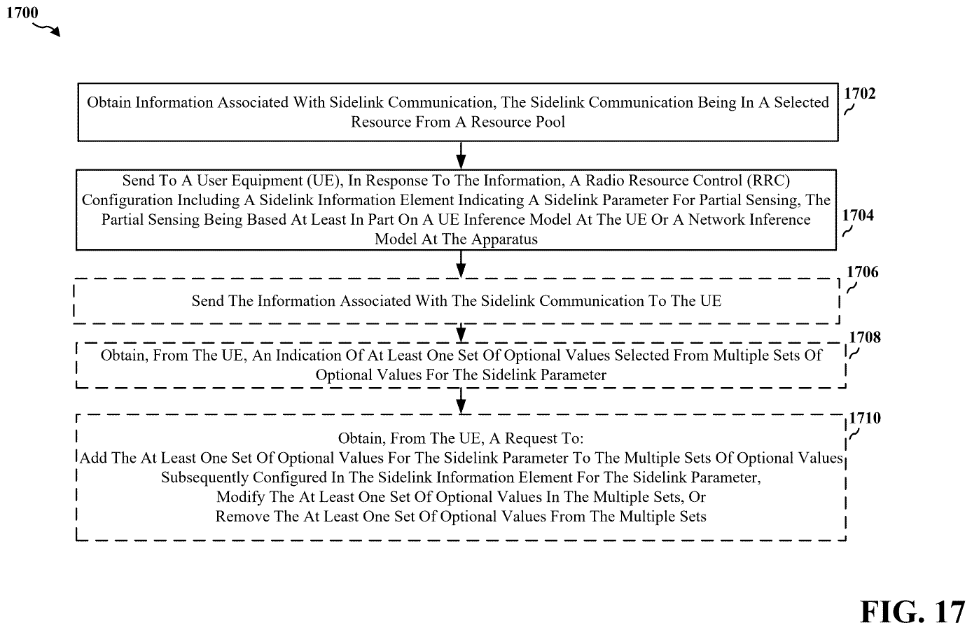

FIG. 17 is a flowchart 1700 of a method of wireless communication. The method may be performed by a network entity or a base station or one or more of its components, for example, the base station 102/180, 610; network entity 1502; disaggregated base station 181 or one or more of its components; one or more of RX processor(s) 670, TX processor(s) 616, or controller(s)/processor(s) 675; the apparatus 1902; or baseband unit(s) 1904 or its components. Optional aspects are illustrated in dashed lines.

At block 1702, the network entity may obtain information associated with sidelink communication, the sidelink communication being in a selected resource from a resource pool. For example, block 1702 may be performed by information component 1940. Obtaining may include, for example, receiving, demodulating, and decoding an encoded and modulated signal including the information using one or more of RX processor(s) 670 or controller(s)/processor(s) 675 such as described with respect to base station 610 in FIG. 6. For instance, referring to the Figures, the network entity 1502 may receive sidelink communication information 1506 from UE 1504. In one example, the sidelink communication information 1506 may include one or more KPIs 1524 indicating performance of UE inference model 1102, 1402 in connection with producing partial sensing parameters. The UE 1504 may select resources 810 in resource pool 800 using partial sensing according to these parameters, such as described with respect to FIG. 8 and any of 9A-9C, as well as FIG. 10.

At block 1704, the network entity may send to a UE, in response to the information, a RRC configuration including a sidelink information element indicating a sidelink parameter for partial sensing, the partial sensing being based at least in part on a UE inference model at the UE or a network inference model at the network entity. For example, block 1704 may be performed by configuration component 1942. Sending may include, for example, encoding, modulating, and transmitting the RRC configuration using one or more of TX processor(s) 616 or controller(s)/processor(s) 675 such as described with respect to base station 610 in FIG. 6. For instance, referring to the Figures, the network entity 1502 may transmit RRC configuration 1538 including IE 1002 to UE 1504. IE 1002 may indicate parameters 1004 for partial sensing, such as random selection, CPS, or PBPS parameters. The partial sensing may be based at least in part on UE inference model 1102, 1402, network inference model 1202, or any combination of the foregoing. For instance, when the UE applies partial sensing to reduce power consumption by reducing channel sensing operations, an inference model at the UE or network's model inference host 304 such as ANN 200 or ML model 730 may be applied to optimize or enhance the partial sensing operation. For example, the network entity or base station 102 as agent 308 may determine via its inference model a set of parameters that may reduce power consumption of UAV swarms, while individual UEs as agents 308 may fine tune these parameters via their respective inference model(s) to trade off communication and device energy efficiency, including device energy consumption metrics and the like. In one example, referring to the RRC parameters of FIG. 10, the UE 104 may originally be indicated to apply full, continuous sensing based on the sidelink allowed resource selection configuration parameter (sl-AllowedResourceSelectionConfig), and its inference model may then indicate the UE 104 to switch from full sensing to partial sensing, including random selection, CPS, or PBPS.

In various examples, the sidelink information element configures a plurality of optional values for the sidelink parameter, the optional values, at least one KPI associated with the sidelink communication, and UE system information are inputs to the UE inference model, and at least one selected value for the sidelink parameter from the optional values is an output of the UE inference model, the partial sensing using the at least one selected value. For instance, referring to the Figures, the base station may flexibly indicate in RRC parameters 1004 of IE 1002 one or more optional values the UE 104 may selectively apply for a given parameter, rather than a mandatory single value the UE is to apply for a given partial sensing. For example, in the case of the allowed resource selection configuration parameter, the base station may provide the UE with a range of parameter options or values c1, c2, c3, c4, and c5, or some other flexible, consecutive or non-consecutive range of values, any one of which the UE may choose for its resource selection. These parameters 1004 may be input into the inference model 1102 of the UE to produce partial sensing parameters 1302. Moreover, UE characteristics may be input into the inference model 1102 of the UE to produce partial sensing parameters 1302. Examples of UE characteristics input to the UE's model 1102 may include one or more KPIs 1524, such as, for example, how the UE's battery is behaving, what is the UE's traffic pattern, or the like. Information as to a system state of the UE, such as its traffic pattern, energy cost, budget, or the like, may also be input into the inference model 1102 to predict beneficial partial sensing parameters. The model 1102 may apply one or more activation functions or other functions to the system state information to output value(s) for one or more sidelink partial sensing parameters 1302. For instance, when producing an allowed resource selection configuration parameter for partial sensing, the model may indicate which of the potential configurations the UE is to apply using one value such as ‘c3’ to indicate random selection, another value such as ‘c2’ to indicate partial sensing, or the like.

In various examples, the information at block 1702 is obtained from the UE and includes: first information including data or measurements of at least one of the UE or other UEs in communication with the UE, and second information including at least one of: a proximity report of the UE, motion information of the UE, environment information of the UE, or device level information of the UE. In various examples, the sidelink information element configures a plurality of optional values for the sidelink parameter, the second information is an input to the network inference model, and the optional values for the sidelink parameter are an output of the network inference model, the partial sensing using at least one selected value from the optional values. For instance, referring to the Figures, the network entity's inference model 1202 may receive as inputs 1204 sidelink communication information 1506, apply activation or other functions to the inputs 1204 according to a same or similar configuration as that described with respect to the UE's inference model 1102, and provide outputs 1206 of values for partial sensing parameters 1302 to be sent in RRC configuration 1538 to the UE such as RRC parameters 1004 of FIG. 10. The sidelink communication information 1506 may include first information 1508 or basic information, such as link measurements from peers of the UE, buffer status for sidelink connections, positioning or location information, and traffic information. The sidelink communication information 1506 may also include second information 1514 or advanced information, such as UE proximity reports 1516, motion information 1518, environment information 1520, or device level information 1522. The outputs from the network inference model 1202 transmitted in IE 1002 may be flexible thresholds, such as a range of values c1-c5 for the allowed resource configuration parameter, from which values the UE may select or possibly input into its own inference model 1102 to determine more fine-tuned partial sensing parameters at the UE. For instance, the UE may select to apply one value c3 within the flexible thresholds c1-c5 for its subsequent partial sensing and resource selection.

In various examples, the sidelink information element is a PBPS and CPS configuration information element that configures a plurality of optional values for the sidelink parameter, the optional values are an output of the network inference model, and at least one selected value for the partial sensing from the optional values is an output of the UE inference model. In various examples, the sidelink information element further includes a first partial sensing parameter indicating whether the partial sensing based at least in part on the UE inference model is allowed; and the sidelink information element further includes a second partial sensing parameter indicating whether the information obtained at the network entity in association with the sidelink communication is input to the network inference model for partial sensing. For instance, referring to the Figures, the IE 1002 may include parameters 1302 such as illustrated and described with respect to FIGS. 13A-13B, which are modified parameters of the PBPS and CPS configuration IE illustrated in FIG. 10, although other parameters may be configured alternatively or additionally. Based on its inference model 1202, the base station 102 may indicate flexible thresholds in these parameters 1302 for sidelink partial sensing. For instance, the base station may provide a list or arranged set or range of values for respective parameters 1302 from which the UE may select based on its own, native, inference model 1102. As a first partial sensing parameter, the base station 102 may provide in the IE 1002 an inference model allowed parameter (sl-PBPS-AIML-allowed-UE) such as illustrated in FIG. 13B, which indicates whether the use of inference model 1102, 1402 at the UE is allowed for partial sensing. As a second partial sensing parameter, the base station 102 may provide in the IE 1002 a network data collection parameter (sl-PBPS-AIML-NW-DataCollect) such as illustrated in FIG. 13B, which indicates whether the network expects sidelink communication information 1506, 1534 or other data collection for its inference model 1202.

In various examples, the information associated with sidelink communication is obtained from other UEs than the UE, the information is an input to the network inference model, and at least one value for the sidelink parameter is an output of the network inference model, the partial sensing using the at least one value, and the information includes at least one of: link measurement data of the other UEs, proximity reports of the other UEs, motion information of the other UEs, environment information of the other UEs, or device level information of the other UEs. For instance, referring to the Figures, the network may collect in sidelink communication information 1506, 1534 data on link measurements. In another example, the sidelink communication information 1506, 1534 which the network entity 1502 may collect is the second information 1514 illustrated and described with respect to FIG. 12, including, for example, proximity UE reports 1516, motion information 1518, environment information 1520, or device level information 1522. Based on this information 1506, 1534 and the inference model 1202 at the network, the network entity 1502 may utilize one or more values from a configuration list of partial sensing parameters for UE resource selection. For instance, the inference model 1202 of the base station may output parameters to be applied or fine-tuned for partial sensing in mode 2 resource allocation. In this aspect, the inputs to the inference model may include not only the information or measurements that the base station collected itself, but also include measurements and data collected from other UEs or other network nodes. For instance, the network entity 1502 may input collected information from the UE and the multiple other UEs into its inference model 1202 to similarly determine partial sensing parameters.

In one example, at block 1706, the network entity may send information associated with the sidelink communication to the UE, the information including at least one of: traces or channel measurement logs associated with other UEs than the UE. For example, block 1706 may be performed by information component 1940. For instance, referring to the Figures, the network entity 1502 may transmit sidelink communication information 1540, 1544 to UE 1504. In one case, the sidelink UE may collect in sidelink communication information 1540, 1544 traces from UEs in its proximity or UEs which it may connect via PC5 discovery. These traces may include, for example, information about the UEs' current power savings schemes, the partial sensing parameter(s) used, and energy costs for current transmissions. These traces may also or alternatively include, for example, traffic information, and current or supported service information, such as traffic periodicities, traffic burst size, traffic arrival rates, and the like for a respective service or traffic type currently being served or which may be served in the future. These traces may also or alternatively include, for example, long term and medium term reliability, decodability, or latency metrics associated with one or more traffic types or services or with one or more groups of UEs. In another case, the sidelink UE may collect in sidelink communication information 1540, 1544 logs for channel measurements from the network entity 1502 or from the various sidelink UEs to which the UE is connected. The other UEs 1532, 1542, 1554 may be those which are in proximity to a particular UE or which supports services in which the UE is interested.

In one example, the sidelink information element configures a plurality of optional values for the sidelink parameter, the information sent at block 1706 is an input to the UE inference model, and at least one selected value for the sidelink parameter from the optional values is an output of the UE inference model, the partial sensing using the at least one selected value. For instance, referring to the Figures, based on the collected, sidelink communication information 1540, 1544 and the inference model 1102 at the UE, the UE 104 may utilize one or more values from a configuration list of partial sensing parameters for UE resource selection. For instance, the inference model 1102, 1402 of the UE may output parameters to be applied or fine-tuned for partial sensing in mode 2 resource allocation. In this aspect, the inputs to the inference model may include not only the information or measurements that the UE collected itself, but also include measurements and data collected from other UEs or other network nodes. For instance, if the UE collected data from multiple other UEs in the wireless communication system, the UE may include this collected information of the other UEs as further inputs to its inference model 1102, 1402 to determine partial sensing parameters.

In one example, the information at block 1702 is obtained from the UE and includes a KPI indicating a performance of the UE inference model, the KPI including a UE energy metric, a communication efficiency metric of the UE, or a failure log of the UE. For instance, referring to the Figures, one example of KPI 1524 is a UE energy metric, such as energy consumption per data unit (Joules per bit), energy consumption statistics over time, a configured energy score, or the like. Another example of KPI 1524 is a communication efficiency metric, such as a data rate, latency, reliability, or other QoS metric associated with the UE or with respective services supported by the UE. A further example of KPI 1524 is a failure log, which may include logs for data transmission failures, radio link failures, service level failures, or the like, which failure may have happened due to partial sensing.

In one example, the sidelink information element configures multiple sets of optional values for the sidelink parameter, and at block 1708, the network entity may obtain, from the UE, an indication of at least one set of optional values selected from the multiple sets, where the multiple sets are an input to a second UE inference model, the at least one set of optional values is an output of the second UE inference model, the at least one set of optional values is an input to the UE inference model, and at least one selected value for the sidelink parameter from the at least one set is an output of the UE inference model, the partial sensing using the at least one selected value. For example, block 1708 may be performed by information component 1940. For instance, referring to the Figures, the determination of flexible thresholds for a given RRC parameter 1004 in IE 1002 for partial sensing may be split between a smaller, inference model 1202 at the network entity 1502 and multiple inference models 1102, 1402 at the UE 1504. Foor example, with reference to FIG. 14, the network entity model 1202 may determine multiple sets of flexible thresholds for an individual parameter at least in part based on information 1506, 1534 provided from UEs, the UE inference model 1402 may determine which single set of these multiple sets of flexible thresholds to use for an individual parameter, and the UE inference model 1102 may determine which flexible threshold in the determined single set to use for that same parameter, at least in part based on the information 1540, 1544. The network entity 1502 may afterwards receive indication 1548 of the selected parameter value(s) produced from UE inference model 1402 from UE 1504, such as the single set of the multiple sets output from UE inference model 1402.

In one example, at block 1710, the network entity may obtain, from the UE, a request to: add the at least one set of optional values to the multiple sets of optional values subsequently configured in the sidelink information element, modify the at least one set of optional values in the multiple sets, or remove the at least one set of optional values from the multiple sets, where the request is based on at least one of: a change in UE state, a KPI associated with the at least one set of optional values, or an output from the UE inference model based on the at least one set of optional values. For example, block 1710 may be performed by information component 1940. For instance, referring to the Figures, the network entity 1502 may receive request 1550 from UE 1504 to add to, modify in, or remove parameter values from subsequent sidelink IEs. In such case, when the UE 1504 sends request 1550 to the network entity 1502 to add, modify, or remove one or more sets of flexible thresholds, in one example, the request may be associated with a change in UE state, such as a change in its mobility, trajectory, scene, or the like. For instance, a vehicle UE may experience a scene change and thus a change in UE state if it exits from a freeway into a city. In another example, the request may be associated with performance KPIs corresponding to the use of one or more sets of flexible thresholds for sidelink partial sensing, such as KPI 1524. In a further example, the UE may indicate to the network one or more sets or lists of flexible thresholds based on its own local inference model 1102, 1402, which indication 1548 the network may consider as a request to fine tune its model or sets of flexible thresholds to be subsequently indicated to the UE.

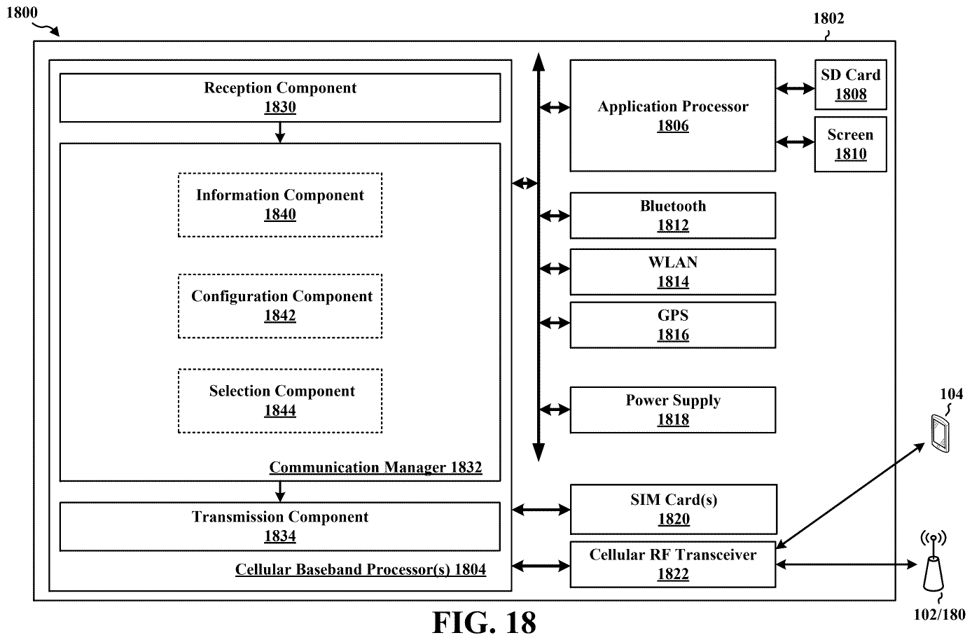

FIG. 18 is a diagram 1800 illustrating an example of a hardware implementation for an apparatus 1802. The apparatus 1802 is a UE and includes one or more cellular baseband processors 1804 (also referred to as a modem) coupled to a cellular RF transceiver 1822 and one or more subscriber identity modules (SIM) cards 1820, an application processor 1806 coupled to a secure digital (SD) card 1808 and a screen 1810, a Bluetooth module 1812, a wireless local area network (WLAN) module 1814, a Global Positioning System (GPS) module 1816, and a power supply 1818. The one or more cellular baseband processors 1804 communicate through the cellular RF transceiver 1822 with the BS 102/180/disaggregated base station 181. For example, the cellular RF transceiver 1822 may correspond to or include the transmitters 654TX, receivers 654RX, and antennas 652 of UE 650.

The one or more cellular baseband processors 1804 may each include a computer-readable medium/one or more memories. The computer-readable medium/one or more memories may be non-transitory. The one or more cellular baseband processors 1804 are responsible for general processing, including the execution of software stored on the computer-readable medium/one or more memories individually or in combination. The software, when executed by the one or more cellular baseband processors 1804, causes the one or more cellular baseband processors 1804 to, individually or in combination, perform the various functions described supra. The computer-readable medium/one or more memories may also be used individually or in combination for storing data that is manipulated by the one or more cellular baseband processors 1804 when executing software. The one or more cellular baseband processors 1804 individually or in combination further include a reception component 1830, a communication manager 1832, and a transmission component 1834. The communication manager 1832 includes the one or more illustrated components. The components within the communication manager 1832 may be stored in the computer-readable medium/one or more memories and/or configured as hardware within the one or more cellular baseband processors 1804. The one or more cellular baseband processors 1804 may be components of the UE 650 and may individually or in combination include the one or more memories 660 and/or at least one of the one or more TX processors 668, at least one of the one or more RX processors 656, and at least one of the one or more controllers/processors 659. For example, the reception component 1830 may include at least the one or more RX processors 656, the transmission component 1834 may include at least the one or more TX processors 668, and the communication manager 1832 may include at least the one or more controllers/processors 659. In one configuration, the apparatus 1802 may be a modem chip and include just the one or more baseband processors 1804, and in another configuration, the apparatus 1802 may be the entire communications device (e.g., see UE 650 of FIG. 6) and include the aforediscussed additional modules of the apparatus 1802.

The communication manager 1832 includes an information component 1840 that is configured to send, to a network entity, information associated with sidelink communication, such as described in connection with block 1602. The information component 1840 may further be configured to send, to the network entity, a KPI indicating a performance of a UE inference model, such as described in connection with block 1604. The information component 1840 may further be configured to obtain, from the network entity or from other UEs, information associated with the sidelink communication, such as described in connection with block 1608. The information component 1840 may further be configured to send, to the network entity, an indication of at least one set of optional values output from a second UE inference model, such as described in connection with block 1610. The information component 1840 may further be configured to send, to the network entity, a request to: add at least one set of optional values for the sidelink parameter to multiple sets of optional values subsequently configured in the sidelink information element for the sidelink parameter, modify the at least one set of optional values in the multiple sets, or remove the at least one set of optional values from the multiple sets, such as described in connection with block 1612. The information component 1840 may further be configured to send data in a selected resource, such as described in connection with block 1616.

The communication manager 1832 further includes a configuration component 1842 that is configured to obtain, from the network entity, a RRC configuration including a sidelink information element indicating a sidelink parameter for partial sensing, such as described in connection with block 1606.

The communication manager 1832 further includes a selection component 1844 that is configured to select, using the partial sensing, a resource from a resource pool for sidelink communication, the partial sensing being based at least in part on the UE inference model at the apparatus or a network inference model at the network entity, such as described in connection with block 1614.

The apparatus may include additional components that perform each of the blocks of the algorithm in the aforementioned flowchart of FIG. 16. As such, each block in the aforementioned flowchart of FIG. 16 may be performed by a component and the apparatus may include one or more of those components. The components may be one or more hardware components specifically configured to carry out the stated processes/algorithm, implemented by one or more processors individually or in combination configured to perform the stated processes/algorithm, stored within a computer-readable medium for implementation by one or more processors, or some combination thereof.

In one configuration, the apparatus 1802, and in particular the one or more cellular baseband processors 1804, includes means for obtaining, from a network entity, a RRC configuration including a sidelink information element indicating a sidelink parameter for partial sensing; means for selecting, using the partial sensing, a resource from a resource pool for sidelink communication, the partial sensing being based at least in part on a UE inference model at the UE or a network inference model at the network entity; and means for sending data in the selected resource.

The aforementioned means may be one or more of the aforementioned components of the apparatus 1802 configured to perform the functions recited by the aforementioned means. As described supra, the apparatus 1802 may include the one or more TX Processors 668, the one or more RX Processors 656, and the one or more controllers/processors 659. As such, in one configuration, the aforementioned means may be at least one of the one or more TX Processors 668, at least one of the one or more RX Processors 656, or at least one of the one or more controllers/processors 659, individually or in any combination configured to perform the functions recited by the aforementioned means.

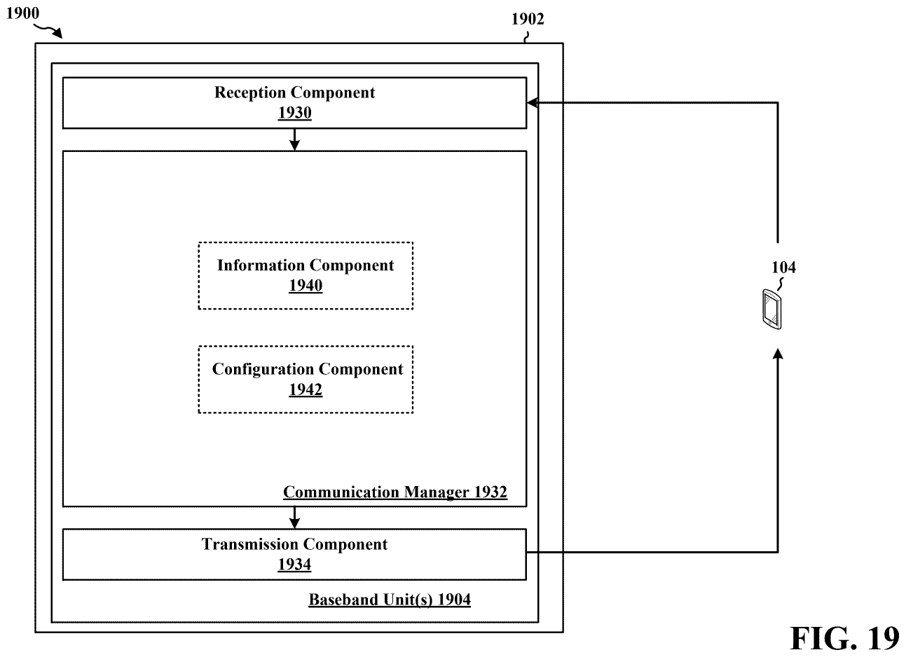

FIG. 19 is a diagram 1900 illustrating an example of a hardware implementation for an apparatus 1902. The apparatus 1902 is a network entity such as a base station, and includes one or more baseband units 1904. The one or more baseband units 1904 communicate through a cellular RF transceiver with the UE 104. For example, the cellular RF transceiver may correspond to or include the transmitters 618TX, receivers 618RX, and antennas 620 of base station 610.

The one or more baseband units 1904 may each include a computer-readable medium/one or more memories. The computer-readable medium/one or more memories may be non-transitory. The one or more baseband units 1904 are responsible for general processing, including the execution of software stored on the computer-readable medium/one or more memories individually or in combination. The software, when executed by the one or more baseband units 1904, causes the one or more baseband units 1904 to, individually or in combination, perform the various functions described supra. The computer-readable medium/one or more memories may also be used individually or in combination for storing data that is manipulated by the one or more baseband units 1904 when executing software. The one or more baseband units 1904 individually or in combination further include a reception component 1930, a communication manager 1932, and a transmission component 1934. The communication manager 1932 includes the one or more illustrated components. The components within the communication manager 1932 may be stored in the computer-readable medium/one or more memories and/or configured as hardware within the one or more baseband units 1904. The one or more baseband units 1904 may be components of the base station 610 and may individually or in combination include the one or more memories 676 and/or at least one of the one or more TX processors 616, at least one of the one or more RX processors 670, and at least one of the one or more controllers/processors 675. For example, the reception component 1930 may include at least the one or more RX processors 670, the transmission component 1934 may include at least the one or more TX processors 616, and the communication manager 1932 may include at least the one or more controllers/processors 675.

The communication manager 1932 includes an information component 1940 that is configured to obtain information associated with sidelink communication, the sidelink communication being in a selected resource from a resource pool, such as described in connection with block 1702. The information component 1940 may be further configured to send information associated with the sidelink communication to the UE, such as described in connection with block 1706. The information component 1940 may be further configured to obtain, from the UE, an indication of at least one set of optional values selected from multiple sets of optional values for a sidelink parameter, such as described in connection with block 1708. The information component 1940 may be further configured to obtain, from the UE, a request to: add the at least one set of optional values for the sidelink parameter to the multiple sets of optional values subsequently configured in the sidelink information element for the sidelink parameter, modify the at least one set of optional values in the multiple sets, or remove the at least one set of optional values from the multiple sets, such as described in connection with block 1710.

The communication manager 1932 further includes a configuration component 1942 that is configured to send to a UE, in response to the information, a RRC configuration including a sidelink information element indicating a sidelink parameter for partial sensing, the partial sensing being based at least in part on a UE inference model at the UE or a network inference model at the apparatus, such as described in connection with block 1704.

The apparatus may include additional components that perform each of the blocks of the algorithm in the aforementioned flowchart of FIG. 17. As such, each block in the aforementioned flowchart of FIG. 17 may be performed by a component and the apparatus may include one or more of those components. The components may be one or more hardware components specifically configured to carry out the stated processes/algorithm, implemented by one or more processors individually or in combination configured to perform the stated processes/algorithm, stored within a computer-readable medium for implementation by one or more processors, or some combination thereof.

In one configuration, the apparatus 1902, and in particular the one or more baseband unit(s) 1904, includes means for obtaining information associated with sidelink communication, the sidelink communication being in a selected resource from a resource pool; and means for sending to a UE, in response to the information, a RRC configuration including a sidelink information element indicating a sidelink parameter for partial sensing, the partial sensing being based at least in part on a UE inference model at the UE or a network inference model at the network entity.

The aforementioned means may be one or more of the aforementioned components of the apparatus 1902 configured to perform the functions recited by the aforementioned means. As described supra, the apparatus 1902 may include the one or more TX Processors 616, the one or more RX Processors 670, and the one or more controllers/processors 675. As such, in one configuration, the aforementioned means may be at least one of the one or more TX Processors 616, at least one of the one or more RX Processors 670, or at least one of the one or more controllers/processors 675, individually or in any combination configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, a processor, at least one processor, and/or one or more processors, individually or in combination, configured to perform or operable for performing a plurality of actions (such as the functions described supra) is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

Similarly as used herein, a memory, at least one memory, a computer-readable medium, and/or one or more memories, individually or in combination, configured to store or having stored thereon instructions executable by one or more processors for performing a plurality of actions (such as the functions described supra) is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, a computer-readable medium, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, a second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processors may in combination execute the respective subset of instruction to accomplish performing actions X, Y, and Z. Alternatively, a single processor may execute the instructions stored on a single memory, or distributed across multiple memories, to accomplish performing actions X, Y, and Z.

The following examples are illustrative only and may be combined with aspects of other embodiments or teachings described herein, without limitation.

Clause 1. An apparatus for wireless communication, comprising: one or more memories; and one or more processors each communicatively coupled with at least one of the one or more memories, the one or more processors, individually or in any combination, operable to cause the apparatus to: obtain, from a network entity, a radio resource control (RRC) configuration including a sidelink information element indicating a sidelink parameter for partial sensing; select, using the partial sensing, a resource from a resource pool for sidelink communication, the partial sensing being based at least in part on a user equipment (UE) inference model at the apparatus or a network inference model at the network entity; and send data in the selected resource.

Clause 2. The apparatus of clause 1, wherein at least one value for the sidelink parameter is an input to the UE inference model.

Clause 3. The apparatus of clause 1 or clause 2, wherein at least one key performance indicator (KPI) associated with the sidelink communication, or UE system information, is an input to the UE inference model.

Clause 4. The apparatus of any of clauses 1 to 3, wherein at least one selected value for the sidelink parameter is an output of the UE inference model, the partial sensing using the at least one selected value.

Clause 5. The apparatus of any of clauses 1 to 4, wherein the sidelink information element configures a plurality of optional values for the sidelink parameter, the optional values are an input to the UE inference model, and at least one selected value for the sidelink parameter from the optional values is an output of the UE inference model, the partial sensing using the at least one selected value.

Clause 6. The apparatus of any of clauses 1 to 5, wherein the one or more processors, individually or in any combination, are further operable to cause the apparatus to: send, to the network entity, information associated with the sidelink communication, wherein at least part of the information is an input to the network inference model, and at least one value for the sidelink parameter is an output of the network inference model.

Clause 7. The apparatus of clause 6, wherein the information includes: first information including data or measurements of at least one of the UE or other UEs in communication with the UE, and second information including at least one of: a proximity report of the UE, motion information of the UE, environment information of the UE, or device level information of the UE, the second information being the at least the part of the information input to the network inference model.

Clause 8. The apparatus of clause 6 or clause 7, wherein the sidelink information element configures a plurality of optional values for the sidelink parameter, and the optional values are an output of the network inference model, the partial sensing using at least one selected value from the optional values.

Clause 9. The apparatus of any of clauses 1 to 8, wherein the sidelink information element is a periodic-based partial sensing (PBPS) and contiguous partial sensing (CPS) configuration information element that configures a plurality of optional values for the sidelink parameter, the optional values are an output of the network inference model, and at least one selected value for the partial sensing from the optional values is an output of the UE inference model.

Clause 10. The apparatus of any of clauses 1 to 9, wherein the sidelink information element further includes a partial sensing parameter indicating whether the partial sensing based at least in part on the UE inference model is allowed.

Clause 11. The apparatus of any of clauses 1 to 10, wherein the sidelink information element further includes a partial sensing parameter indicating whether information sent to the network entity in association with the sidelink communication is to be input to the network inference model for partial sensing.

Clause 12. The apparatus of any of clauses 1 to 11, wherein the one or more processors, individually or in any combination, are further operable to cause the apparatus to: obtain, from the network entity or from other UEs, information associated with the sidelink communication, wherein the sidelink information element configures a plurality of optional values for the sidelink parameter, the information is an input to the UE inference model, and at least one selected value for the sidelink parameter from the optional values is an output of the UE inference model, the partial sensing using the at least one selected value.

Clause 13. The apparatus of clause 12, wherein the information includes at least one of: traces or channel measurement logs associated with the other UEs.

Clause 14. The apparatus of any of clauses 1 to 12, wherein information associated with the sidelink communication from other UEs than the UE is an input to the network inference model, and at least one value for the sidelink parameter is an output of the network inference model, the partial sensing using the at least one value.

Clause 15. The apparatus of clause 14, wherein the information includes at least one of: link measurement data of the other UEs, proximity reports of the other UEs, motion information of the other UEs, environment information of the other UEs, or device level information of the other UEs.

Clause 16. The apparatus of any of clauses 1 to 15, wherein the one or more processors, individually or in any combination, are further operable to cause the apparatus to: send, to the network entity, a key performance indicator (KPI) indicating a performance of the UE inference model, wherein the KPI is a UE energy metric, a communication efficiency metric of the UE, or a failure log of the UE.

Clause 17. The apparatus of any of clauses 1 to 16, wherein the sidelink information element configures multiple sets of optional values for the sidelink parameter, the multiple sets are an input to a second UE inference model, at least one set of optional values selected from the multiple sets is an output of the second UE inference model, the at least one set of optional values is an input to the UE inference model, and at least one selected value for the sidelink parameter from the at least one set is an output of the UE inference model, the partial sensing using the at least one selected value.

Clause 18. The apparatus of clause 17, wherein the multiple sets of optional values are respectively associated with a UE state, wherein the multiple sets of optional values are an output from the network inference model based on reported information associated with the sidelink communication, the reported information being an input to the network inference model and including at least one of: UE data or key performance indicators (KPIs), and wherein the at least one set of optional values output from the second UE inference model is based on additional information associated with the sidelink communication input to the second UE inference model.

Clause 19. The apparatus of clause 17 or clause 18, wherein the one or more processors, individually or in any combination, are further operable to cause the apparatus to: send, to the network entity, an indication of the at least one set of optional values output from the second UE inference model.

Clause 20. The apparatus of any of clauses 1 to 19, wherein the one or more processors, individually or in any combination, are further operable to cause the apparatus to: send, to the network entity, a request to: add at least one set of optional values for the sidelink parameter to multiple sets of optional values subsequently configured in the sidelink information element for the sidelink parameter, modify the at least one set of optional values in the multiple sets, or remove the at least one set of optional values from the multiple sets, wherein the request is based on at least one of: a change in UE state, a key performance indicator (KPI) associated with the at least one set of optional values, or an output from the UE inference model based on the at least one set of optional values.

Clause 21. An apparatus for wireless communication, comprising: one or more memories; and one or more processors each communicatively coupled with at least one of the one or more memories, the one or more processors, individually or in any combination, operable to cause the apparatus to: obtain information associated with sidelink communication, the sidelink communication being in a selected resource from a resource pool; and send to a user equipment (UE), in response to the information, a radio resource control (RRC) configuration including a sidelink information element indicating a sidelink parameter for partial sensing, the partial sensing being based at least in part on a UE inference model at the UE or a network inference model at the apparatus.

Clause 22. The apparatus of clause 21, wherein the sidelink information element configures a plurality of optional values for the sidelink parameter, wherein the optional values, at least one key performance indicator (KPI) associated with the sidelink communication, and UE system information are inputs to the UE inference model, and wherein at least one selected value for the sidelink parameter from the optional values is an output of the UE inference model, the partial sensing using the at least one selected value.

Clause 23. The apparatus of clause 21 or clause 22, wherein the information is obtained from the UE and includes: first information including data or measurements of at least one of the UE or other UEs in communication with the UE, and second information including at least one of: a proximity report of the UE, motion information of the UE, environment information of the UE, or device level information of the UE, and wherein the sidelink information element configures a plurality of optional values for the sidelink parameter, the second information is an input to the network inference model, and the optional values for the sidelink parameter are an output of the network inference model, the partial sensing using at least one selected value from the optional values.

Clause 24. The apparatus of any of clauses 21 to 23, wherein the sidelink information element is a periodic-based partial sensing (PBPS) and contiguous partial sensing (CPS) configuration information element that configures a plurality of optional values for the sidelink parameter, the optional values are an output of the network inference model, and at least one selected value for the partial sensing from the optional values is an output of the UE inference model; wherein the sidelink information element further includes a first partial sensing parameter indicating whether the partial sensing based at least in part on the UE inference model is allowed; and wherein the sidelink information element further includes a second partial sensing parameter indicating whether the information obtained at the apparatus in association with the sidelink communication is input to the network inference model for partial sensing.

Clause 25. The apparatus of any of clauses 21 to 24, wherein the information associated with sidelink communication is obtained from other UEs than the UE, wherein the information is an input to the network inference model, and at least one value for the sidelink parameter is an output of the network inference model, the partial sensing using the at least one value; and wherein the information includes at least one of: link measurement data of the other UEs, proximity reports of the other UEs, motion information of the other UEs, environment information of the other UEs, or device level information of the other UEs.

Clause 26. The apparatus of any of clauses 21 to 25, wherein the one or more processors, individually or in any combination, are further operable to cause the apparatus to: send the information associated with the sidelink communication to the UE, the information including at least one of: traces or channel measurement logs associated with other UEs than the UE; and wherein the sidelink information element configures a plurality of optional values for the sidelink parameter, the information is an input to the UE inference model, and at least one selected value for the sidelink parameter from the optional values is an output of the UE inference model, the partial sensing using the at least one selected value.

Clause 27. The apparatus of any of clauses 21 to 26, wherein the information is obtained from the UE and includes a key performance indicator (KPI) indicating a performance of the UE inference model, the KPI including a UE energy metric, a communication efficiency metric of the UE, or a failure log of the UE.

Clause 28. The apparatus of any of clauses 21 to 27, wherein the sidelink information element configures multiple sets of optional values for the sidelink parameter, and the one or more processors, individually or in any combination, are further operable to cause the apparatus to: obtain, from the UE, an indication of at least one set of optional values selected from the multiple sets, wherein the multiple sets are an input to a second UE inference model, the at least one set of optional values is an output of the second UE inference model, the at least one set of optional values is an input to the UE inference model, and at least one selected value for the sidelink parameter from the at least one set is an output of the UE inference model, the partial sensing using the at least one selected value; and obtain, from the UE, a request to: add the at least one set of optional values to the multiple sets of optional values subsequently configured in the sidelink information element, modify the at least one set of optional values in the multiple sets, or remove the at least one set of optional values from the multiple sets, wherein the request is based on at least one of: a change in UE state, a key performance indicator (KPI) associated with the at least one set of optional values, or an output from the UE inference model based on the at least one set of optional values.

Clause 29. A method of wireless communication performable at a user equipment (UE), comprising: obtaining, from a network entity, a radio resource control (RRC) configuration including a sidelink information element indicating a sidelink parameter for partial sensing; selecting, using the partial sensing, a resource from a resource pool for sidelink communication, the partial sensing being based at least in part on a UE inference model at the UE or a network inference model at the network entity; and sending data in the selected resource.

Clause 30. A method of wireless communication performable at a network entity, comprising: obtaining information associated with sidelink communication, the sidelink communication being in a selected resource from a resource pool; and sending to a user equipment (UE), in response to the information, a radio resource control (RRC) configuration including a sidelink information element indicating a sidelink parameter for partial sensing, the partial sensing being based at least in part on a UE inference model at the UE or a network inference model at the network entity.

Clause 31. An apparatus for wireless communication, comprising: means for obtaining, from a network entity, a radio resource control (RRC) configuration including a sidelink information element indicating a sidelink parameter for partial sensing; means for selecting, using the partial sensing, a resource from a resource pool for sidelink communication, the partial sensing being based at least in part on a UE inference model at the UE or a network inference model at the network entity; and means for sending data in the selected resource.

What is claimed is:

1. An apparatus for wireless communication, comprising:
one or more memories; and
one or more processors each communicatively coupled with at least one of the one or more memories, the one or more processors, individually or in any combination, operable to cause the apparatus to:
obtain, from a network entity, a radio resource control (RRC) configuration including a sidelink information element indicating a sidelink parameter for partial sensing;
select, using the partial sensing, a resource from a resource pool for sidelink communication, the partial sensing being based at least in part on a user equipment (UE) inference model at the apparatus or a network inference model at the network entity; and
send data in the selected resource.

2. The apparatus of claim 1, wherein at least one value for the sidelink parameter, at least one key performance indicator (KPI) associated with the sidelink communication, or UE system information, is an input to the UE inference model.

3. The apparatus of claim 1, wherein at least one selected value for the sidelink parameter is an output of the UE inference model, the partial sensing using the at least one selected value.

4. The apparatus of claim 1, wherein the sidelink information element configures a plurality of optional values for the sidelink parameter, the optional values are an input to the UE inference model, and at least one selected value for the sidelink parameter from the optional values is an output of the UE inference model, the partial sensing using the at least one selected value.

5. The apparatus of claim 1, wherein the one or more processors, individually or in any combination, are further operable to cause the apparatus to:
send, to the network entity, information associated with the sidelink communication,
wherein at least part of the information is an input to the network inference model, and at least one value for the sidelink parameter is an output of the network inference model.

6. The apparatus of claim 5, wherein the information includes:
first information including data or measurements of at least one of the UE or other UEs in communication with the UE, and
second information including at least one of: a proximity report of the UE, motion information of the UE, environment information of the UE, or device level information of the UE, the second information being the at least the part of the information input to the network inference model.

7. The apparatus of claim 5, wherein the sidelink information element configures a plurality of optional values for the sidelink parameter, and the optional values are an output of the network inference model, the partial sensing using at least one selected value from the optional values.

8. The apparatus of claim 1, wherein the sidelink information element is a periodic-based partial sensing (PBPS) and contiguous partial sensing (CPS) configuration information element that configures a plurality of optional values for the sidelink parameter, the optional values are an output of the network inference model, and at least one selected value for the partial sensing from the optional values is an output of the UE inference model.

9. The apparatus of claim 1, wherein the sidelink information element further includes a partial sensing parameter indicating whether the partial sensing based at least in part on the UE inference model is allowed.

10. The apparatus of claim 1, wherein the sidelink information element further includes a partial sensing parameter indicating whether information sent to the network entity in association with the sidelink communication is to be input to the network inference model for partial sensing.

11. The apparatus of claim 1, wherein the one or more processors, individually or in any combination, are further operable to cause the apparatus to:
obtain, from the network entity or from other UEs, information associated with the sidelink communication, the information including at least one of: traces or channel measurement logs associated with the other UEs,
wherein the sidelink information element configures a plurality of optional values for the sidelink parameter, the information is an input to the UE inference model, and at least one selected value for the sidelink parameter from the optional values is an output of the UE inference model, the partial sensing using the at least one selected value.

12. The apparatus of claim 1, wherein information associated with the sidelink communication from other UEs than the UE is an input to the network inference model, and at least one value for the sidelink parameter is an output of the network inference model, the partial sensing using the at least one value.

13. The apparatus of claim 12, wherein the information includes at least one of: link measurement data of the other UEs, proximity reports of the other UEs, motion information of the other UEs, environment information of the other UEs, or device level information of the other UEs.

14. The apparatus of claim 1, wherein the one or more processors, individually or in any combination, are further operable to cause the apparatus to:
send, to the network entity, a key performance indicator (KPI) indicating a performance of the UE inference model,
wherein the KPI is a UE energy metric, a communication efficiency metric of the UE, or a failure log of the UE.

15. The apparatus of claim 1, wherein the sidelink information element configures multiple sets of optional values for the sidelink parameter, the multiple sets are an input to a second UE inference model, at least one set of optional values selected from the multiple sets is an output of the second UE inference model, the at least one set of optional values is an input to the UE inference model, and at least one selected value for the sidelink parameter from the at least one set is an output of the UE inference model, the partial sensing using the at least one selected value.

16. The apparatus of claim 15,
wherein the multiple sets of optional values are respectively associated with a UE state,
wherein the multiple sets of optional values are an output from the network inference model based on reported information associated with the sidelink communication, the reported information being an input to the network inference model and including at least one of: UE data or key performance indicators (KPIs), and
wherein the at least one set of optional values output from the second UE inference model is based on additional information associated with the sidelink communication input to the second UE inference model.

17. The apparatus of claim 15, wherein the one or more processors, individually or in any combination, are further operable to cause the apparatus to:
send, to the network entity, an indication of the at least one set of optional values output from the second UE inference model.

18. The apparatus of claim 1, wherein the one or more processors, individually or in any combination, are further operable to cause the apparatus to:
send, to the network entity, a request to:
add at least one set of optional values for the sidelink parameter to multiple sets of optional values subsequently configured in the sidelink information element for the sidelink parameter,
modify the at least one set of optional values in the multiple sets, or
remove the at least one set of optional values from the multiple sets,
wherein the request is based on at least one of: a change in UE state, a key performance indicator (KPI) associated with the at least one set of optional values, or an output from the UE inference model based on the at least one set of optional values.

19. A method of wireless communication performable at a user equipment (UE), comprising:
obtaining, from a network entity, a radio resource control (RRC) configuration including a sidelink information element indicating a sidelink parameter for partial sensing;
selecting, using the partial sensing, a resource from a resource pool for sidelink communication, the partial sensing being based at least in part on a UE inference model at the UE or a network inference model at the network entity; and
sending data in the selected resource.

20. An apparatus for wireless communication, comprising:
means for obtaining, from a network entity, a radio resource control (RRC) configuration including a sidelink information element indicating a sidelink parameter for partial sensing;
means for selecting, using the partial sensing, a resource from a resource pool for sidelink communication, the partial sensing being based at least in part on a UE inference model at the UE or a network inference model at the network entity; and
means for sending data in the selected resource.
